(19) United States
(12) Patent Application Publication
(10) Pub. No.: US 2005/0214464 A1
(43) Pub. Date: Sep. 29, 2005

(54) Material such as hide, skin, leather or fur for use in manufacturing leather product, leather product, method for preparing said material, and method for manufacturing leather product

(76) Inventors: Takashi Moriyoshi, Kagawa (JP); Shunsaku Katoh, Kagawa (JP); Masaki Minamiura, Kagawa (JP); Tsutomu Nakanishi, Kagawa (JP); Kazuyuki Oro, Kagawa (JP)

Correspondence Address: FULBRIGHT AND JAWORSKI LLP, 555 S. FLOWER STREET, 41ST FLOOR, LOS ANGELES, CA, 90071, US

(21) Appl. No.: 10/516,654

(22) PCT Filed: May 1, 2003
(86) PCT No.: PCT/JP03/05567

§ 371 Date: May 10, 2005

(30) Foreign Application Priority Data
May 2, 2002 (JP) 2002-130848
Oct. 28, 2002 (JP) 2002-312965
Dec. 26, 2002 (JP) 2002-378139

(51) Int. Cl. B05D 3/10

(52) U.S. Cl. 427/307; 428/904

(57) ABSTRACT

A material to be processed into leather products such as leather and fur characterized in that at least one effective component of an aromatic component, a deodorant component, a drug effective component, an antibacterial component, an anti-mold component, and an insect-controlling component, or a fat or oil component such as a fatliquoring agent is impregnated into tissue and fiber of animal hide or skin using a high pressure fluid as a medium.

### FIELD OF THE INVENTION

The present invention relates to a material to be processed into a leather product such as natural leather and fur of an animal such as a mammal, bird and reptile, and leather products thereof such as leather and fur, as well as a method for producing the material to be processed into the leather products and a method for producing the leather products.

### BACKGROUND ART

Conventionally, natural leather and fur taken from animals, for example, mammal such as deer, cow, sheep and pig, reptiles such as alligator, lizard and snake, and birds such as emu and orchard have been used as a material for various leather products and fur products, but recent development of techniques of manufacturing synthetic leather has reduced costs of general leather products with the result that a demand for natural leather products is stagnated.

However, although technique of manufacturing synthetic leather was developed, unique texture of leather contributing to such as hand feeling and physical property as a material of products are far excellent in natural leather products as compared with synthetic leather products, and a demand exists for natural leather products rather than for synthetic resin products, since they ensure luxurious feeling as compared with synthetic leather products. In addition, natural leather products have a unique odor, and this has an effect of further enhancing luxurious feeling of products. On the other hand, some consumers do not like this odor, and this odor has been a cause for preventing expansion of the range of purchasers.

Therefore, natural leather products whose unique odor has been suppressed by adding an aromatic component or a deodorant component thereto have been commercially sold. Further, in order to add value to products, products with an antibacterial, anti-mold or insect-controlling component added thereto have also been commercially sold. Conventionally, those components are added to a leather material such as by having them directly adhered thereto in a dissolved state effected by a wet impregnating method or coating method, or by encapsulating various components in microcapsules and having the same adhered to the leather material by spray-coating with binder.

However, these methods can only have various components adhered to a surface of leather, and an effect of diffusing aromatic fragrance or providing anti-bacterial capability is merely temporarily produced. That is, hides or skins, from which leather is prepared, generally of a unique tissue structure composed of a grain layer, a hypodermis, a dermis and the like, and it is not easy to make the aforementioned various components impregnate into the interior of a tissue. In addition, for application of microcapsules, extra works such as crushing of capsules are necessitated. Further, when a component is directly adhered by a wet impregnating method or a coating method, leather loses breathability, and further durability is reduced. Therefore, excellent physical properties of natural leather is lost, thereby, an excellent quality as a leather product is deteriorated and, at the same time, a product value is seriously deteriorated.

On the other hand, when leather is produced from the aforementioned hides or skins of such as a mammal, reptile and bird, leather is produced by first performing a skin (hide) removing step of removing skin from such an animal, and performing a tailoring step in which the skin is subjected to antiseptic-treatment and, thereafter, subjecting tailoring-treated skin to a tanning step. Further, the tanning step comprises a water-immersing step for removing salt for storage contained in a tailoring-treated skin, a defatting step of removing oil and fat derived from an animal remaining in the skin, a tanning step of newly injecting synthetic oil and fat in the skin which has been dried and cleaned after defatting and, thereafter, a fat-adding step for giving flexibility and drape to the skin. In a fat-adding step, as shown in FIG. 11, the tanned skin which has been tanning-treated is immersed in a solution of fatliquoring agent in which fatliquoring agent is dispersed (immersion step), and extra water injected in the skin is removed and dried (drying step). As fatliquoring agent, synthetic oil and fat for fat liquoring for commercially available animal skins is used. Through such a drying step, the tanned skin (leather) is produced.

However, in the aforementioned previous step of producing leather, an aqueous solution in which fatliquoring agent is dispersed is used in a fat-adding step which is a part of a tanning step, and a large amount of waste solution is generated after treatment. Accordingly, it is necessary to perform treatment of rendering waste solution harmless for the purpose of preventing environmental pollution. In addition, after fatliquoring agent is injected, skin must be dried in order to remove extra water, drape is lost again due to heat, leading to loss in excellent physical property of leather, and excellent quality as leather products is deteriorated and, at the same time, a quality value is seriously deteriorated.

### DISCLOSURE OF THE INVENTION

The present invention has been conceived in order to solve the aforementioned problems, and an object of the present invention is to provide a leather product such as leather and fur, and a material to be processed into leather products that are unlikely to reduce physical properties of natural leather, and a quality of a leather product in any case, and that can retain efficacy of various effective components such as aromatic effect and antibacterial effect for a long term.

In order to solve those problems, the present invention has been made as a material to be processed into leather products such as leather and fur, a leather product, and a method for producing the material to be processed into leather products, and a leather product thereof. Herein, by the material to be processed into leather products is meant a material before a leather product is produced by processing into a desired shape, to which material a tanning step has been subjected. The material is not necessarily limited to a specific form, but the material is generally in the form of a sheet.

A material to be processed into leather products such as leather and fur of the present invention is characterized in that at least one effective component of an aromatic component, a deodorant component, a drug effective component, an antibacterial component, an anti-molding component and an insect-controlling component, or a fat or oil component such as a fatliquoring agent is impregnated into tissue and fiber of animal hide or skin using a high pressure fluid as a medium. Herein, the effective component or the fat or oil component can be impregnated into tissue and fiber of hide or skin using a high pressure fluid as a medium in the state of so-called tanned leather whose tanning step has been completed, or those components can be impregnated using a high pressure fluid as a medium at a stage of a leather raw material before completion of a tanning step. An effective component such as an aromatic component, a deodorant component, a drug effective component, an antibacterial component, an anti-mold component and an insect-controlling component is impregnated using a high pressure fluid as a medium in the state of so-called tanned leather, for which mainly a tanning step has been completed and a fat or oil component such as a fatliquoring agent is mainly impregnated using a high pressure fluid as a medium at a stage of a leather raw material before completion of a tanning step. In particular, a fatliquoring agent is impregnated in a fat-adding step in a tanning step. Therefore, “impregnated into tissue and fiber of animal hide or skin” means to include any of these cases.

In addition, a leather product such as leather and fur of the present invention is characterized in that at least one effective component of an aromatic component, a deodorant component, a drug effective component, an antibacterial component, an anti-mold component and an insect-controlling component, or a fat or oil component such as a fatliquoring agent is impregnated into tissue and fiber of animal hide or skin using a high pressure fluid as a medium. A leather product of the present invention can be constructed by processing the aforementioned material, in which any one of the effective component and fat or oil component is impregnated into tissue and fiber of hide or skin, but alternatively, a leather product of the present invention is not constructed of the material to be processed into leather products, and various components to be added can be directly impregnated into a leather product after it has been processed using a high pressure fluid as a medium. Therefore, “impregnated into tissue and fiber of animal hide or skin” means to include both cases.

Further, a method for producing a material to be processed into leather products such as leather and fur is characterized in that the material is produced by impregnating at least one effective component of an aromatic component, a deodorant component, a drug effective component, an antibacterial component, an anti-mold component and an insect-controlling component into tissue and fiber of animal hide or skin using a high pressure fluid as a medium.

It is also possible to remove impurities such as fat and water remaining in tissue and fiber before the aforementioned effective component is impregnated into the tissue and the fiber of animal hide or skin. Removal of impurities in this case can be performed using a high pressure fluid.

As the aromatic component, the deodorant component, the drug effective component, the antibacterial component, the anti-mold component or the insect-controlling component, an artificially synthesized reagent can be used, but preferably, a natural effective component extracted from a natural creature such an animal, a plant, an insect, a fish and the like, or its processed product is used.

According to the present invention, various effects such as aromatic effect, deodorant effect, antibacterial effect, anti-mold effect, and insect-controlling effect can be maintained over a long term as compared with the previous method of merely adhering a component on a surface of a leather material, such as a wet immersing method, a coating method and a method using microcapsules.

Moreover, since a component is impregnated using the aforementioned high pressure fluid as a medium, property of leather or fur is not deteriorated and, in particular, there is an effect of not deteriorating property which is originally possessed by a natural leather, such as stretchability, durability, water-absorbing property, and dissipation, regarding a natural leather material whose property was remarkably deteriorated by the previous method of directly adhering an effective component.

As a result, there can be provided a leather product to which an additional value such as aromatic effect, deodorant effect, drug effect, antibacterial effect, anti-mold effect, and insect-controlling effect is added, and which does not deteriorate property of leather, particularly, property which is originally possessed by a natural leather.

In particular, since a gap between fibers is small in a deer leather as compared with other animal leathers such as cow leather, sheep leather and pig leather, an effective component is difficult to be impregnated as compared with other animal leathers. However, in the present invention, since an effective component is added to leather using a high pressure fluid as a medium, an effective component can be suitably impregnated due to a force of the high pressure fluid of impregnating into a fine part.

Further, since a gap between fibers of a deer leather is small, once an effective component is added, a component is not unexpectedly flown, therefore, an effective component can be retained for a long term.

Further, since an effective component is impregnated to a deep part in tissue and fiber of hide or skin, there is the effect that even in the case of a leather product having a grain side on a surface side, or even in a so-called back skin product in which a grain side is on a back side (that is, a hypodermis side is on a surface side), there can be provided a leather product which can retain an effective component for a long term.

In addition, other object of the present invention is to provide a leather product, which does not generate a large amount of a waste solution at a step of tanning a skin or fur of an animal which is a raw material of a material to be processed into leather products, and does not deteriorate physical property of a natural leather material, and quality as a leather product at all.

In order to attain this other object, a leather product such as leather and fur, and a material to be processed into leather products in which a fat or oil component such as a fatliquoring agent is impregnated into tissue and fiber of animal hide or skin using a high pressure fluid as a medium, as described above, are provided.

In addition, there are provided a method for producing a leather product such as leather and fur in which a leather product is produced by impregnating a fat or oil component such as a fatliquoring agent into tissue and fiber of animal hide or skin, and a method for producing a material to be processed into leather products in which the material is produced similarly.

Like this, by impregnating a fat or oil component such as a fatliquoring agent into tissue and fiber of hide or skin raw material using a high pressure fluid as a medium, there is the effect that drawbacks of generation of a waste solution which is required to be disposed separately, and short maintenance of drape as in the previous method using a wet method can be overcome.

It is also possible to impregnate any of the aforementioned aromatic component, deodorant component, drug effective component, antibacterial component, anti-mold component and insect-controlling component in addition to this fat or oil component in tissue and fiber of hide or skin using a high pressure fluid as a medium.

Thereby, like the aforementioned case, there can be provided a leather product to which an additional value such as aromatic effect, deodorant effect, drug effect, antibacterial effect, anti-mold effect, and insect-controlling effect is imparted, and which does not deteriorate property of leather, particularly, property which is originally possessed by a natural leather.

In the present invention, a kind of hide or skin such as leather and fur is not particularly limited, but an animal, particularly, a mammal is mainly applied. Among a mammal, examples of a leather product having marketability include a cow, a sheep, a pig, a deer. Examples of high quality fur leather product (fur product) having marketability include a mink, a chinchilla, a mole, a fox and the like. In addition, the present invention can be also applied to a weasel, a camel, a kangaroo, a reindeer, a moose and the like. These products of a mammal require various processings not only in order to obtain antibacterial effect and anti-mold effect but also prevent an animal odor, and technique using a high pressure fluid as a medium as in the present invention can be suitably used in response to those requirements. Further, leather of a reptile such as an alligator, a lizard, a snake and the like, and a bird leather having a narrow air of a feather part and a wideerea of hide or skin part, such as an emu and an orchard require antibacterial effect, anti-mold effect, and deodorant effect, and the present invention can be suitably applied.

In the present invention, as a high pressure fluid, a fluid at various pressures can be used, and a supercritical fluid or a subsupercritical fluid excellent in permeability to leather is preferably used. In addition, it is preferable to use the kind of fluid that has high solubility of an effective component as a medium for injecting an effective component for imparting function into leather, and does not deteriorate leather. For example, carbon dioxide, nitrous oxide, trifluoromethane, or a mixture of two or more kinds of them is used. Further, in order to enhance solubility of an effective component in a high pressure fluid, it is also possible to mix a small amount of about 1 to 10% of an organic solvent such as alcohol, chloroform and ether, relative to the number of molls of a high pressure fluid as used.

### BRIEF DESCRIPTION OF THE DRAWINGS

FIG. 1 is a schematic block view of an apparatus for producing a material to be processed into leather products to which an aromatic component is added as one embodiment.

FIG. 2 is a main part-enlarged cross-sectional view showing a structure of leather.

FIG. 3 is a main part-enlarged cross-sectional view showing a structure of leather in the state where a grain layer has been peeled.

FIG. 4 is a schematic block view of an apparatus for producing a material to be processed into leather products to which an aromatic component is added as other embodiment.

FIG. 5 is a schematic block view showing a step of producing a material to be processed into leather products of other embodiment.

FIG. 6 is a schematic block view showing details of a tanning step.

FIG. 7 is a schematic block view showing details of a fat-adding step.

FIG. 8 is a schematic block view of an apparatus for performing a fat-adding step.

FIG. 9 is a schematic block view of an apparatus for performing a fat-adding step of other embodiment.

FIG. 10 is a schematic block view showing a fat-adding step of other embodiment.

FIG. 11 is a schematic block view showing the previous fat-adding step.

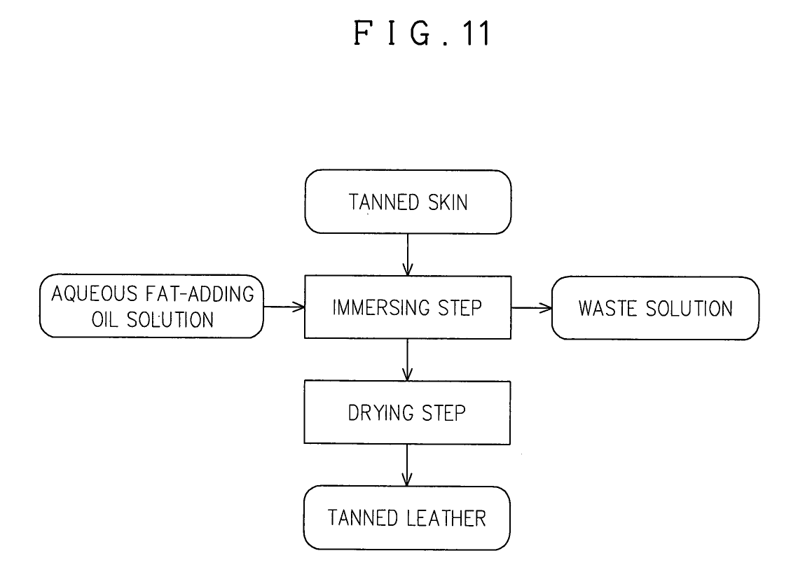

### BEST MODE FOR CARRYING OUT THE INVENTION

Hereinafter, best mode for carrying out the present invention will be explained in accordance with the drawings.

(Embodiment 1)

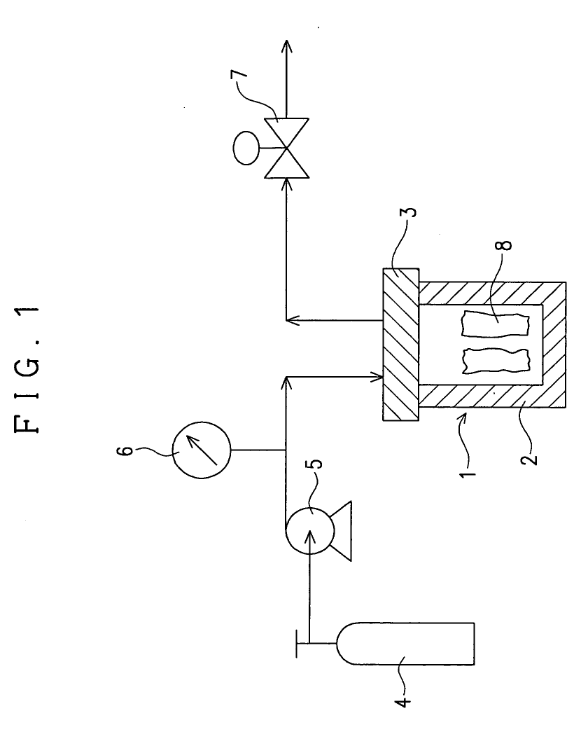

An apparatus used for producing a material to be processed into leather products of the present embodiment is provided with a high pressure cell 1, a bomb 4, a high pressure pump 5, a manometer 6, and a back pressure valve 7 as shown in FIG. 1.

The high pressure cell 1 is for accommodating a raw material of an aromatic component, and leather to which the aromatic component should be added, and the aromatic component is adhered to leather in this high pressure cell 1. This high pressure cell 1 made of a pressure resistant stainless, and is constructed of a cell body 2 and a lid 3.

The bomb 4 is for storing a fluid which is to be a source of a high pressure fluid and, as a kind of a fluid, carbon dioxide is used. The high pressure pump 5 is a pump for supplying a fluid in the bomb 4 to a high pressure cell 1, and a pressure of the high pressure pump 5 is measured by the manometer 6.

The back pressure valve 7 can be opened and closed at a prescribed pressure, and an operational pressure can be maintained at a constant prescribed value. Further, by reducing a pressure by opening the back pressure valve 7, a high pressure fluid in the high pressure cell 1 is released to outside of the system.

In addition, an apparatus for producing a material to be processed into leather products of the present embodiment is provided with a piping part (shown by a diagram).

Then, an embodiment of a method for producing a material to be processed into leather products to which an aromatic component is added using such apparatus will be explained.

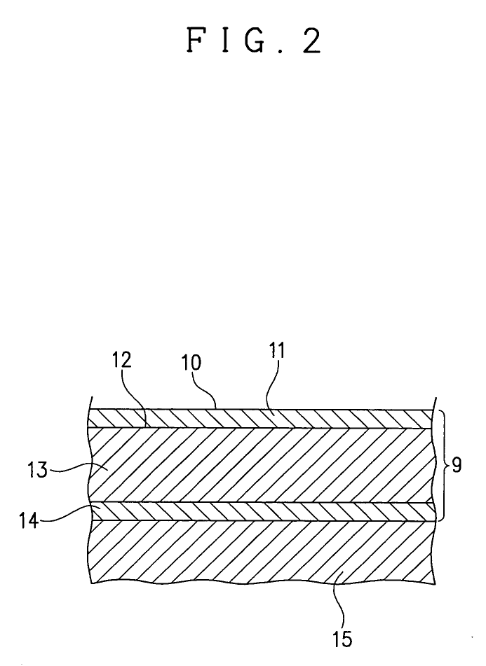

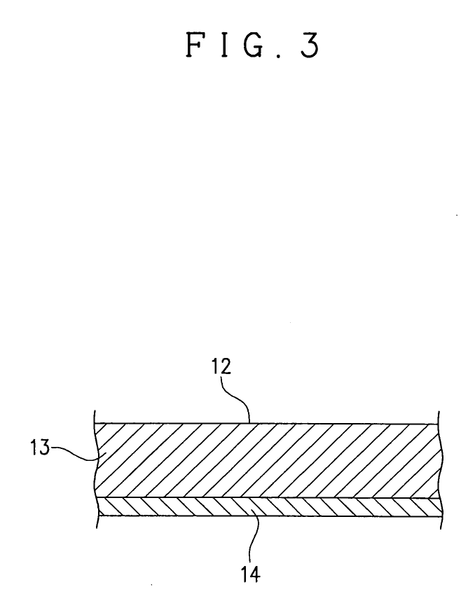

First, leather 8 is disposed in a high pressure cell 1, and a raw material of an aromatic component is disposed in the high pressure cell 1. As this leather, a deer leather was used in the present embodiment. This deer leather is so-called tanned leather obtained by subjecting a raw material leather to pre-treatment such as tanning treatment and completing a tanning step. That is, a deer skin part 9 (outside a meat part 15) which is a raw material skin has a structure composed of a grain layer 11 having a grain side 10 on a surface, a hypodermis 13, and a dermis 14 as shown in FIG. 2, and is used as a raw material of a material to be processed into leather products in the present embodiment in the state where a grain layer 11 is peeled and a nubuck 12 is exposed on the surface (of course peeled from a meat part 15) as shown in FIG. 3. Leather which is a raw material of a material to be processed into leather products is formed into a sheet in the present embodiment.

Then, a constant temperature bath (not shown) which accommodates a high pressure cell 1 is set at an objective temperature, and a releasing pressure of a back pressure valve 7 is set at an objective pressure and, thereafter, carbon dioxide is supplied to a high pressure cell 1 from a bomb 4 via a high pressure pump 5.

Carbon dioxide becomes a supercritical fluid under the conditions of a temperature not lower than 31.1° C. (critical temperature) and a pressure not lower than 73 atm (critical pressure), and supercritical state can be maintained by the aforementioned temperature setting of a constant temperature bath and pressure setting with a backpressure valve 7.

After a temperature and a pressure in a high pressure cell 1 reach prescribed values, carbon dioxide is flown for a prescribed time. Thereupon, impurities such as a fat or oil matter and water remaining in tissue and gaps between fibers of leather are extracted and removed by an extracting force of supercritical carbon dioxide, and a space for adhering an effective component to be added can be sufficiently maintained.

After removal of impurities is completed, a back pressure valve 7 is opened to remove carbon dioxide in a high pressure cell 1, a high pressure cell 1 is opened, and a raw material containing an effective component such as an aromatic component is additionally charged. Subsequently, the interior of a high pressure cell 1 is set again at prescribed temperature and pressure, and is allowed to stand for a prescribe time. Thereby, an aromatic component is impregnated into tissue and gaps between fibers of leather, and is added to leather.

This will be explained in more detail. First, an aromatic component is extracted from a raw material containing an aromatic component with supercritical carbon dioxide, and a mixed fluid of supercritical carbon dioxide and an aromatic component is impregnated into tissue and gaps between fibers of leather.

Since a skin part 9 of a deer which is a raw material of the leather has a peculiar tissue structure composed of a grain layer 11, a hypodermis 13, and a dermis 14 as described above, an aromatic component is originally impregnated into the interior of a tissue with difficulty. Since, in particular, a deer leather has regularity in orientation of fibers such as the presence of fibers in longitudinal and traverse directions, and has a narrower gap between fibers as compared with other animal leathers such as cow leather, sheep leather and pig leather, an aromatic component is impregnated with difficulty as compared with other animal leathers.

However, in the present embodiment, by using a supercritical fluid having a force of impregnating into a fine part as a medium, an aromatic component can be added to a deep part of tissue and gaps between fibers.

Further, since a gap between fibers of a deer leather is small, once an aromatic component is adhered, an aromatic component is not unexpectedly flown, action of releasing an aromatic component can be maintained over a long term. In addition, although a fat is contained between fibers of a deer leather, in the present embodiment, since carbon dioxide is used as a supercritical fluid, a fat present in tissue and gaps between fibers of a deer leather is suitably removed due to a dissolving force and an extracting force of supercritical carbon dioxide for a fat.

Subsequently, by rendering a back pressure valve 5 in the released state, a flow path becomes in a pressure-reduced state, supercritical carbon dioxide is returned to the gaseous state by reduction in a pressure, and supercritical carbon dioxide is naturally dissipated and removed from leather. On the other hand, an aromatic component is adsorbed and captured in tissue and fiber of leather, and remains in leather.

Like this, a leather material to which an aromatic component is adhered and aromatic effect is imparted is produced and, since carbon dioxide becomes a supercritical fluid under the conditions of a temperature not lower than 31.1° C. (critical temperature) and a pressure not lower than 73 atm (critical temperature) as described above, a temperature can be set at a relatively low temperature, and deterioration of leather and an aromatic component due to heat can be prevented.

(Embodiment 2)

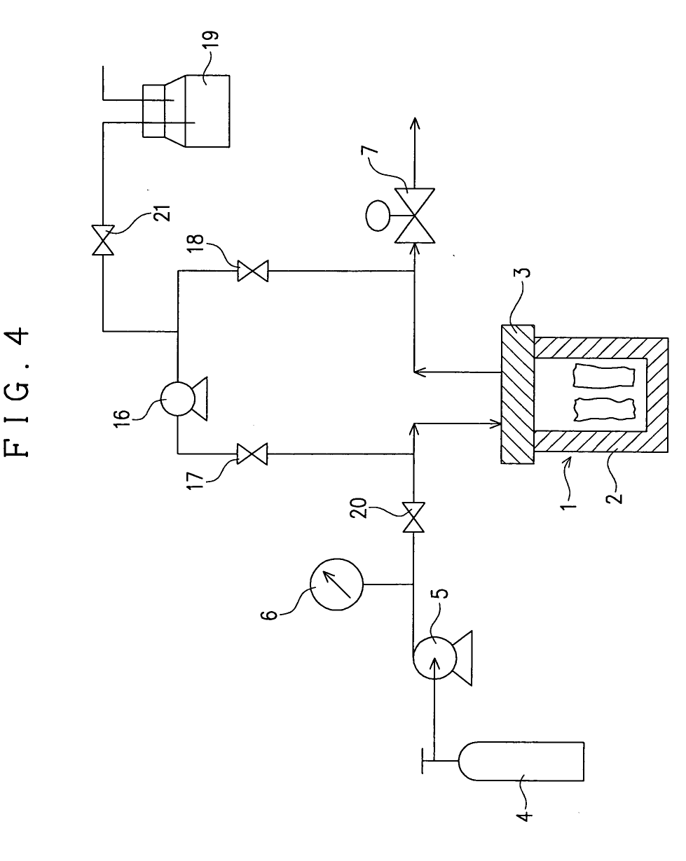

An apparatus for producing a material to be processed into leather products of the present embodiment is provided with a circulating pump 16 and a container 19 for accommodating an aromatic component in addition to the high pressure cell 1, the bomb 4, the high pressure pump 5, the manometer 6 and the back pressure valve 7 of the aforementioned embodiment 1, as shown in FIG. 4.

While a raw material of an aromatic component is directly accommodated in a high pressure cell 1 in the aforementioned embodiment 1, the material is accommodated in a container 19 for accommodating an aromatic component, and is supplied to a high pressure cell 1 from the accommodating container 19 in the present embodiment.

More specifically explaining, first, valves 17 and 18 in a circulating flow path are in the closed state, and a valve 20 is in the opened state, carbon dioxide is supplied to a high pressure cell 1 from a bomb 4 as in the embodiment 1. After a temperature and a pressure in a high pressure cell 1 reach prescribed values as in the embodiment 1, when allowed to stand for a prescribed time, supercritical carbon dioxide is impregnated into tissue and gaps between fibers of a deer leather, and fat present in tissue and gaps between fiber of the deer leather is suitably removed.

Then, a valve 20 on a side of supplying carbon dioxide is closed, and a back pressure valve 7 is opened to release carbon dioxide in a high pressure cell 1, and the system is brought into the vacuum state using a vacuum pump (not shown) via a back pressure valve. Subsequently, by opening valves 17 and 18 in a circulating flow path and a valve 21 on a side of supplying an aromatic component, an aromatic component is injected in a high pressure cell 1.

Subsequently, a valve 20 is opened to flow again carbon dioxide into a high pressure cell 1, and a temperature and a pressure are set at prescribed values and, thereafter, valves 20 and 21 on a supply side, and a back pressure valve 7 are closed, and valves 17 and 18 in a circulating flow path are opened to actuate a circulating pump 16. Thereby, an aromatic component is suitably impregnated into tissue and gaps between fibers of a deer leather from which a fat has been already removed.

In the present embodiment, since a supercritical fluid having a force of impregnating into a fine part is used as a medium, an aromatic component can be added to a deep part of tissue and gaps between fibers, and once an aromatic component is added, an aromatic component can be suitably prevented from unexpectedly flying.

(Embodiment 3)

In the present embodiment, a deodorant component was used in place of an aromatic component of the aforementioned embodiment 1. As an apparatus, the same apparatus as that of embodiments 1 and 2 was used.

This deodorant component does not impart aromatic flavor, but an odor of a deer leather could be vanished. As a result, a leather product having a demand value can be also provided to consumers who dislike an odor of a deer leather.

(Embodiment 4)

In the present embodiment, a drug effective component was used in place of an aromatic component of the embodiment 1. As an apparatus, the same apparatus as that of embodiments 1 and 2 was used. Specifically, a herb extract such as lavender, Melissa officinalis, and lemon balm having sedative effect was produced, and was adhered to leather using the aforementioned supercritical fluid as a medium. In this case, by wearing a deer leather product after treatment, sedative effect is exerted and, at the same time, wet pack effect having action on all herb extract can be expected.

(Embodiment 5)

In the present embodiment, an antibacterial component was added to leather in place of an aromatic component of the embodiment 1. Specifically, a natural antibacterial component such as an antibacterial component extracted from catechin, bamboo, and bamboo grass was produced, and was adhered to leather using the aforementioned supercritical fluid as a medium. In this case, antibacterial effect can be manifested in a deer leather product itself, and a product can be retained hygienic over a long term.

(Embodiment 6)

An anti-mold component was added to leather in place of an aromatic component of the embodiment 1. As an apparatus, the same apparatus as that of embodiments 1 and 2 was used. Since an anti-mold component is impregnated into the interior of leather using a supercritical fluid as a medium, anti-mold effect can be maintained over a long term. In particular, since a natural leather has a weak resistance force against a mold, the effect of capable of maintaining anti-mold effect over a long term is extremely great for providing a leather product.

(Embodiment 7)

In the present embodiment, an insect-controlling component was added to leather in place of an aromatic component of the embodiment 1. As an apparatus, the same apparatus as that of embodiments 1 and 2 was used. Since an insect-controlling component is impregnated into the interior of leather by using a supercritical fluid as a medium, the insect-controlling effect can be maintained over a long term. Since a natural leather has little insect-controlling effect, the effect of being capable of maintaining the insect-controlling effect over a long term is extremely great for providing a leather product.

(Embodiment 8)

In the present embodiment, a cow leather was used as leather in place of a deer leather of embodiments 1 to 7, and an aromatic component was added. As an apparatus, the same apparatus as that of embodiments 1 and 2 was used.

Since a supercritical fluid having a force of impregnating into a fine part is used as a medium also in the present embodiment, an aromatic component can be added to a deep part of tissue and gaps between fibers of a cow leather and, once an aromatic component is added, unexpected flying of an aromatic component can be suitably prevented. In addition, since carbon dioxide was used as a supercritical fluid, fat present in gaps between fibers of a cow leather is suitably removed due to a dissolving force and an extracting force of superciritical carbon dioxide for fat.

In the present embodiment, an aromatic component is added to a leather material of a cow leather, but a deodorant component, a drug effective component, an antibacterial component, an anti-mold component or an insect-controlling component can be added in place of an aromatic component.

(Embodiment 9)

In the present embodiment, an aromatic component was added using a pig leather as leather in place of a deer leather of embodiments 1 to 7. As an apparatus, the same apparatus as that of embodiments 1 and 2 was used.

Also in the present embodiment, since a supercritical fluid having a force of impregnating into a fine part is used as a medium, an aromatic component can be added to a deep part of tissue and gaps between fibers of a pig leather and, after the addition, unexpected flying of an aromatic component can be suitably prevented and, moreover, since carbon dioxide was used as a supercritical fluid, fat present between fibers of a pig leather is suitably removed due to a dissolving force and an extracting force of supercritical carbon dioxide for a fat.

In the present embodiment, an aromatic component was added to leather of a pig leather, but a deodorant component, a drug effective component, an antibacterial component, an anti-mold component, or an insect-controlling component can be also added in place of an aromatic component.

(Embodiment 10)

In the present embodiment, an aromatic component was added by using sheep leather as leather in place of deer leather of embodiments 1 to 7. As an apparatus, the same apparatus as that of embodiments 1 to 2 was used.

Also in the present embodiment, since a supercritical fluid having a force of impregnating into a fine part is used as a medium, an aromatic component can be added to a deep part of the tissue and gaps between fibers of sheep leather and, after the addition, unexpected flying of an aromatic component can be suitably prevented and, moreover, since carbon dioxide was used as a supercritical fluid, fat present between fibers of sheep leather is suitably removed due to a dissolving force and an extracting force of supercritical carbon dioxide for a fat.

In the present embodiment, an aromatic component was added to leather of sheep leather, but a deodorant component, a drug effective component, an antibacterial component, an anti-mold component or an insect-controlling component can be also added in place of an aromatic component.

(Embodiment 11)

In the present embodiment, an aromatic component was added by using an alligator leather as leather in place of a deer leather of embodiments 1 to 7. As an apparatus, the same apparatus as that of embodiments 1 and 2 was used.

Also in the present embodiment, since a supercritical fluid having a force of impregnating into a fine part is used as a medium, an aromatic component can be added to a deep part of tissue and gaps between fibers of an alligator leather and, after the addition, unexpected flying of an aromatic component can be suitably prevented and, moreover, since carbon dioxide was used as a supercritical fluid, fat present between fibers of an alligator leather is suitably removed due to a dissolving force and an extracting force of supercritical carbon dioxide for a fat.

In the present embodiment, an aromatic component was added to leather of an alligator leather, but a deodorant component, a drug effective component, an antibacterial component, an anti-mold component, or an insect-controlling component can be also added in place of an aromatic component.

(Embodiment 12)

In the present embodiment, an aromatic component was added using a snake leather as leather in place of a deer leather of embodiments 1 to 7. As an apparatus, the same apparatus as that of embodiments 1 and 2 was used.

Also in the present embodiment, since a supercritical fluid having a force of impregnating into a fine part is used as a medium, an aromatic component can be added to a deep part of tissue and gaps between fibers of a snake leather and, after the addition, unexpected flying of an aromatic component can be suitably prevented and, moreover, since carbon dioxide was used as a supercritical fluid, fat present between fibers of a snake leather is suitably removed due to a dissolving force and an extracting force of supercritical carbon dioxide for fat.

In the present embodiment, an aromatic component was added to a leather material of a snake leather, but a deodorant component, a drug effective component, an antibacterial component, an anti-mold component, or an insect-controlling component can be also added in place of an aromatic component.

(Embodiment 13)

In the present embodiment, an aromatic component was added using leather of an orchard (generally termed ostrich) as leather in place of a deer leather of embodiments 1 to 7. As an apparatus, the same apparatus as that of embodiments 1 and 2 was used.

Also in the present embodiment, since a supercritical fluid having a force of impregnating into a fine part is used as a medium, an aromatic component can be added to a deep part of tissue and gaps between fibers of an orchard leather and, after the addition, unexpected flying of an aromatic component can be suitably prevented and, moreover, since carbon dioxide is used as a supercritical fluid, fat present between fibers of an orchard leather is suitably removed due to a dissolving force and an extracting force of supercritical carbon dioxide for a fat.

In the present embodiment, an aromatic component of an orchard leather was added, but a deodorant component, a drug effective component, an antibacterial component, an anti-mold component, or an insect-controlling component can be also added in place of an aromatic component.

(Embodiment 14)

In the present embodiment, an aromatic component was added using a rabbit fur as leather in place of a deer leather of embodiments 1 to 7. As an apparatus, the same apparatus as that of embodiments 1 and 2 was used.

Also in the present embodiment, since a supercritical fluid having a force of impregnating into a fine part is used as a medium, an aromatic component can be added to a deep part of tissue and gaps between fibers of a rabbit fur and, after the addition, unexpected flying of an aromatic component can be suitably prevented and, moreover, since carbon dioxide is used as a supercritical fluid, fat present between fibers of a rabbit fur is suitably removed due to a dissolving force and an extracting force of supercritical carbon dioxide for a fat.

In the present embodiment, an aromatic component was added to leather of a rabbit fur, but a deodorant component, a drug effective component, an antibacterial component, an anti-mold component, or an insect-controlling component can be also added in place of an aromatic component.

(Embodiment 15)

While embodiments 1 to 14 were an embodiment of adding various components to leather obtained by subjecting a leather raw material to pre-treatment such as a tanning treatment, the present embodiment is an embodiment characterized in a tanning step which is pre-treatment of leather manufacturing, in particular, a fat-adding step of adding a fatliquoring agent. Steps other than a fat-adding step are performed as in a step of producing a general leather product. As a skin raw material, skins of a mammal such as a deer, cow, sheep, and pig, and a reptile such as an alligator, lizard, and snake are used.

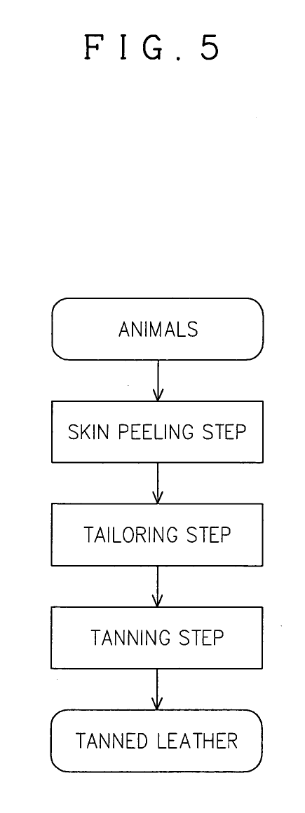

A step for producing a material to be processed into leather products will be explained in accordance with FIG. 5. First, a skin peeling step of peeling a skin from an animal is performed. Then, a tailoring step of performing skin antiseptic treatment is performed. In a tailoring step, a skin is primarily stored by salt-immersing a skin with a salt (sodium chloride) for preventing rottenness of a natural leather, and freezing it.

When, a tailoring-treated skin is subjected to a tanning step for regaining drape of leather and producing leather which is to be a raw material of the leather product. As used herein, a “tanning step” is not a narrow sense tanning step using a so-called tanning agent, but refers to a broad sense tanning step from after tailoring treatment to fat-adding and staining. After completion of the tanning step, leather is processed into a desired shape depending on a product, thereby, a leather product is produced.

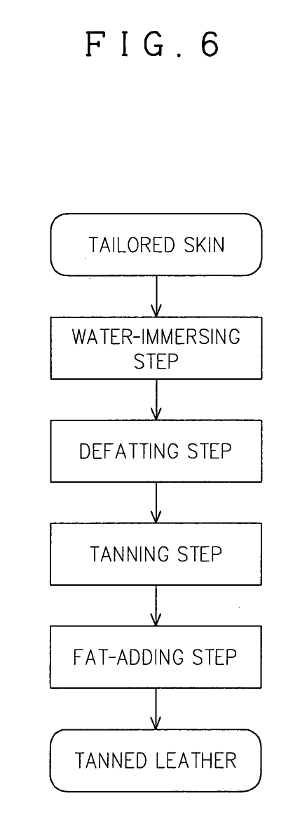

The aforementioned tanning step will be explained in more detail based on FIG. 6. First, a water-immersing step for removing a salt for storage contained in a skin which has been tailoring-treated is performed. In a water-immersing step, a salt in the interior of leather is extracted and removed by washing leather with water, at the same time with thawing.

Then, a defatting step of removing a fat or oil matter remaining in a skin is performed. This is a step which is performed for preventing rottenness of leather by removing a natural fat or oil component derived from an animal remaining in a skin. Mainly, by immersing a skin in an aqueous solution of a soap or a neutral detergent, defatting is performed.

Then, a tanning step of injecting newly a synthetic fat or oil component in a skin which has been dried and cleaned after defatting is performed. This tanning step is performed for imparting durability to a skin, and making posttreatment easy. As a kind of a synthetic fat or oil component, chromium alum or a mixed solution of chromium formate and an aqueous sodium chloride solution is used. Generally, this step is called chromium tanning. However, in addition to chromium tanning, a method such as vegetable tannin tanning, oil tanning, synthetic tanning can be also adopted.

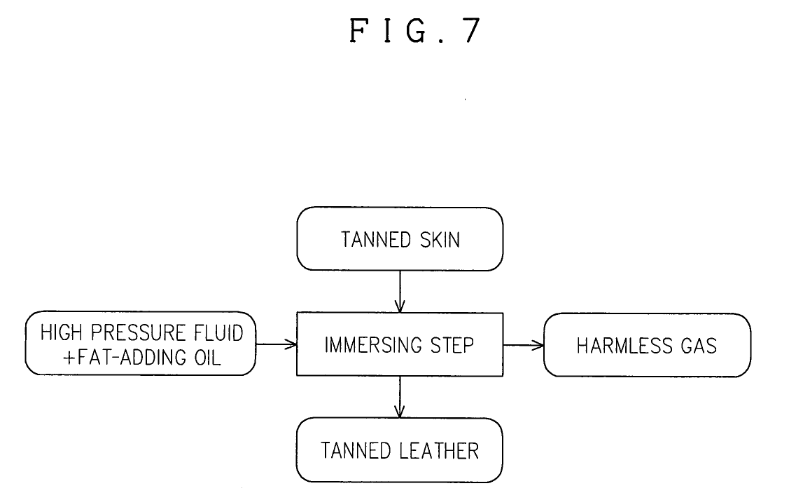

Thereafter, a fat-adding step for imparting flexibility and drape to a skin is performed. A fat-adding step will be explained in more detail based on FIG. 7. First, an immersing step of immersing leather which has been subjected to tanning treatment such as chromium tanning in an aqueous solution in which a fat-adding oil (fatliquoring agent) is dissolved, is performed. Next, a drying step of removing extra water injected in leather is performed. As a fatliquoring agent, a commercially available fatliquoring agent can be used. More particularly, animal oils such as a fish oil, beef foot fat or wool grease, and a lard oil, castor oil, palm oil or olive oil-based vegetable oils, and synthetic fatliquoring agents such as synthetic fatty acid ester, ester oil, amino acid having a long chain alkyl group, alkyl phosphate ester, sulfated oil, sulfonated oil, and sulfited oil can be used depending on an animal species of hide or skin material.

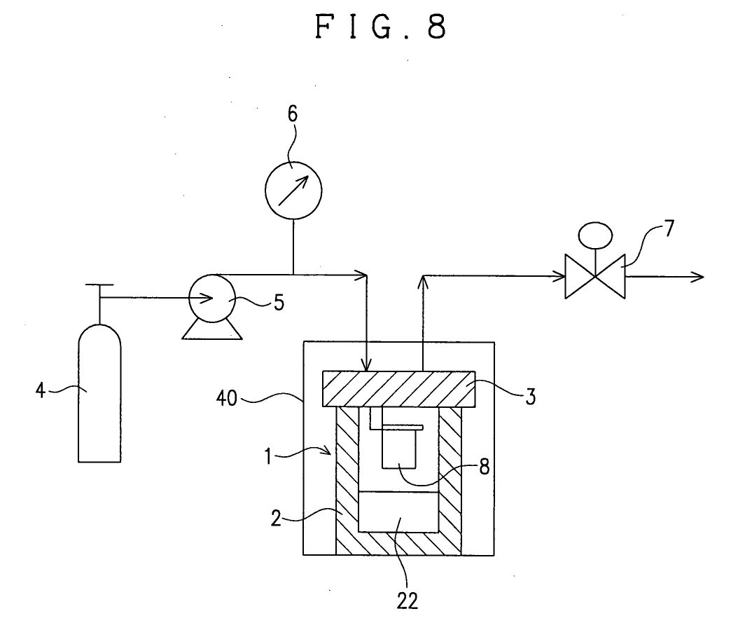

Then, regarding a fat-adding step which is a most characteristic step of the present embodiment, first, an apparatus used for performing the fat-adding step will be explained based on FIG. 8.

An apparatus used in a fat-adding step of the present embodiment has fundamentally the same construction as that of the apparatus of embodiment 1 shown in FIG. 1. That is, an apparatus of the present embodiment is provided with a high pressure cell 1, a bomb 4, a high pressure pump 5, a manometer 6, a back pressure valve 7, and a constant temperature bath 40 as shown in FIG. 8. The high pressure cell 1 is for accommodating a high pressure fluid, a skin raw material, and a fat-adding oil, and a fat-adding oil component is injected in a skin raw material in this high pressure cell 1. This high pressure cell 1 is made of a pressure resistant stainless, and is constructed of a cell body 2 and a lid 3.

The bomb 4 is for storing a fluid which is to be a source of a high pressure fluid and, as a kind of a fluid, carbon dioxide is used. The high pressure pump 5 is a pump for supplying a fluid in the bomb 4 to a high pressure cell 1, and a pressure of the high pressure pump 5 is measured with the aforementioned manometer 6.

The back pressure valve 7 can be opened and closed at a prescribed pressure, and an operational pressure can be retained at a constant prescribed value. Further, by reducing a pressure by opening the back pressure valve 7, a high pressure fluid in a high pressure cell 1 is released to the outside of the system. In addition, the apparatus for performing a fat-adding step is provided with a piping part (shown by a diagram).

Then, the case where a fat-adding step is performed using the apparatus will be explained. First, a skin raw material 8 is disposed in a high pressure cell 1. As this skin raw material, a deer skin was used in the present embodiment. This deer skin has been subjected to a tanning step (chromium tanning) as shown in FIG. 6. A skin part 9 (outside a meat part 15) of a deer which is a skin raw material has a structure composed of a grain layer 11 having a grain side 10 on a surface, a hypodermis 13, and a dermis 14 as shown in FIG. 2 and, as shown in FIG. 3, this is used as a skin raw material in the present embodiment in the state where a grain layer 11 is peeled and a nubuck 12 is exposed on a surface (of course peeled from a meat part 15). At this time point, a fatliquoring agent 22 has not been placed yet.

Then, a constant temperature bath 40 which accommodates a high pressure cell 1 is set at an objective temperature, and a releasing pressure of a back pressure valve 7 is set at an objective pressure and, thereafter, carbon dioxide is supplied to a high pressure cell 1 from a bomb 4 via a high pressure pump 5. Carbon dioxide becomes a supercritical fluid under conditions of a temperature not lower than 31.1° C. (critical temperature) and a pressure not lower than 73 atm (critical pressure), and supercritical state can be maintained by setting a temperature of the aforementioned constant temperature bath and setting a pressure of a back pressure valve 7.

After a temperature and a pressure in a high pressure cell 1 reach prescribed values, carbon dioxide is flown for a prescribed time. Thereupon, impurities such as a natural fat or oil matter and water remaining in tissue and gaps between fibers of hide or skin raw material are completely removed due to an extracting force of supercritical carbon dioxide, and a space for injecting a fatliquoring agent can be sufficiently maintained.

After completion of removal of impurities, a back pressure valve 7 is opened to remove carbon dioxide containing an oil matter and water as impurities in a high pressure cell 1, and a high pressure cell 1 is opened to additionally charge a fatliquoring agent 22. Subsequently, the interior of a high pressure cell 1 is set at a prescribed temperature and a prescribed pressure again, and is allowed to stand for a prescribed time. Thereby, a fatliquoring agent 22 is impregnated into tissue and gaps between fibers of hide or skin raw material.

This is explained in more detail. First, a fatliquoring agent is extracted with supercritical carbon dioxide, and a mixed fluid of supercritical carbon dioxide and a fatliquoring agent is impregnated into tissue and between fibers of hide or skin raw material. Since a skin part 9 of a deer which is a skin raw material has a peculiar tissue structure composed of a grain layer 11, a hypodermis 13, and a dermis 14, a fatliquoring agent is originally impregnated into the interior of a tissue with difficulty. In particular, since a deer leather has no regularity in orientation of fibers such as the presence of fibers in longitudinal and transverse directions, and a gap between fibers is small as compared with other animal leather such as cow leather, sheep leather and pig leather, a fatliquoring agent is impregnated with difficulty as compared with other animal skin raw materials.

However, in the present embodiment, by using a supercritical fluid having a force of impregnating into a fine part as a medium, a fatliquoring agent can be impregnated to a deep part of tissue and gaps between fibers.

Further, since a gap between fibers of a deer leather is small, once a fatliquoring agent is adhered, a fatliquoring agent is not unexpectedly detached, and drape of hide or skin can be maintained over a long term. In addition, although a natural fat is contained between fibers of a deer leather, since carbon dioxide is used as a supercritical fluid in the present embodiment, a natural fat derived from an animal present between fibers of a deer leather is suitably removed due to a dissolving force and an extracting force of supercritical carbon dioxide for fat, and rottenness becomes difficult.

Subsequently, by bringing a back pressure valve 7 into the released state, a flow path is brought into the reduced pressure state, supercritical carbon dioxide is returned to the gaseous state due to reduction in a pressure, and supercritical carbon dioxide is naturally dissipated and removed from a skin raw material. On the other hand, since a fatliquoring agent is adsorbed and captured in tissue and fiber of hide or skin, it remains in leather.

Like this, leather with a fatliquoring agent adhered thereto is produced and, since carbon dioxide becomes a supercritical fluid under the conditions of a temperature of not lower than 31.1° C. (critical temperature) and a pressure of not lower than 73 atm (critical pressure) as described above, a temperature can be set at a relatively low temperature, and deterioration of hide or skin raw material and a fatliquoring agent due to heat can be prevented.

(Embodiment 16)

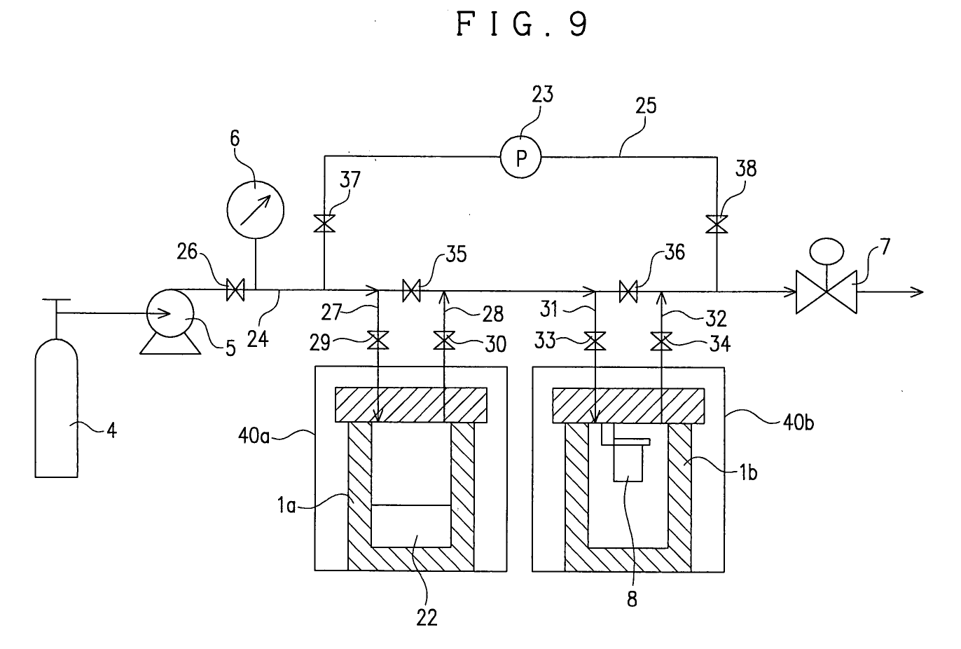

An apparatus of the present embodiment is provided with a circulating pump 23, in addition to the high pressure cell 1, the bomb 4, the high pressure pump 5, the manometer 6 and the back pressure valve 7 of the embodiment 15, as shown in FIG. 9. This circulating pump 23 is provided in a circulating flow path 25 which is provided in addition to a flow path 24 from the bomb to the back pressure valve 7.

In addition, while a fat-adding oil 22 and a skin raw material 8 are directly accommodated in a high pressure cell 1 in the embodiment 15, a high pressure cell is divided into a high pressure cell 1a exclusively used for extracting a fat-adding oil 22 and a high pressure cell 1b exclusively used for injecting a fat-adding oil to a skin raw material 8, and respective cells are provided with exclusive use constant temperature baths 40a and 40b in the present embodiment.

A valve is provided between a high pressure pump 5 and a manometer 6 in a flow path 24. In addition, valves 29 and 30 are provided in a forward path 27 to, and a return path 28 from one high pressure cell 1a, respectively. Further, valves 33 and 34 are provided in a forward path 31 to, and a return path 32 from other high pressure cell 1b, respectively. Further, a valve 35 is provided in a flow path 24 between a forward path 27 to, and a return path 28 from one high pressure cell 1a, and a valve 36 is provided in a flow path 24 between a forward path 31 and a return path 32 from other high pressure cell lb. Further, two valves 37 and 38 are provided in a circulating flow path 25.

Then, the case where a fat-adding step of the present embodiment is performed using the aforementioned apparatus will be explained.

First, impurities remaining in the interior of hide or skin raw material 8 are removed. In this case, valves 26, 35, 33 and 34 are “opened”, and valves 29, 30, 36, 37 and 38 are “closed”. In addition, a back pressure bulb 7 is set so that it is opened at a prescribed pressure. Thereby, carbon dioxide is supplied to a high pressure cell 1b in which a skin raw material 8 is accommodated.

After carbon dioxide is injected in a high pressure cell 1b, and after a temperature and a pressure in a high pressure cell 1b reach prescribed values as in the embodiment 15, when allowed to stand for a prescribed time, supercritical carbon dioxide is impregnated into tissue and gaps between fibers of hide or skin raw material 8, and a fat present in the tissue and gaps between the fibers is suitably removed

Then, procedure of removing injected supercritical carbon dioxide from a high pressure cell 1b is performed. In this case, the opened and closed states of each valve are almost the same as those at the time of removing impurities, but is different in that a valve 26 is “closed”. In this state, after a back pressure valve 7 is opened to release carbon dioxide in a high pressure cell 1a, the system is brought into the vacuum state using a vacuum pump (not shown) via a back pressure valve 7. Thereby, supply of carbon dioxide from a bomb 4 is stopped, and supercritical carbon dioxide in a high pressure cell 1b is discharged from a return path 32 to the outside of a high pressure cell 1b, and is further discharged to the outside of the system through a back pressure valve 7.

Then, carbon dioxide is supplied to a high pressure cell 1a in which a fatliquoring agent 22 is accommodated and, at the same time, a fatliquoring agent 22 together with supercritical carbon dioxide is supplied to a high pressure cell 1b. In this case, valves 26, 29, 30, 33 and 34 are “opened” and, at the same time, valves 35, 36, 37 and 38 are “closed”. In addition, a back pressure valve 7 is set so that it is opened at a prescribed pressure. Thereby, carbon dioxide is supplied from a bomb 4 to a high pressure cell 1a to extract a fatliquoring agent 22, and the fatliquoring agent 22 together with supercritical carbon dioxide is supplied to a high pressure cell 1b in which a skin raw material 8 is accommodated.

Then, a fatliquoring agent 22 is made to carry a skin raw material 8. In this case, valves 29, 30, 33, 34, 37 and 38 are “opened” and, at the same time, valves 26, 35 and 36 are “closed”. In addition, a back pressure valve 7 is set so that it is opened at a prescribed pressure. Thereby, a fatliquoring agent 22 together with supercritical carbon dioxide is circulated in a circulating flow path 25, a high pressure cell 1a and a high pressure cell 1b without newly supplying carbon dioxide from a bomb 4.

Thereafter, valves 26, 35, 33 and 34 are opened and, at the same time, valves 29, 30, 36, 37 and 38 are closed, carbon dioxide is flown again into a high pressure cell 1b from a bomb 4, a temperature and a pressure are set at prescribed values and, thereafter, a valve 26 on a supply side, and a back pressure valve 7 are closed, and valves 37 and 38 in a circulating flow path 25 are opened to actuate a circulating pump 23. Thereby, a fatliquoring agent is suitably impregnated into tissue and gaps between fiber of a deer skin as a skin raw material from which a fat has been already removed.

Also in the present embodiment, since a supercritical fluid having a force of impregnating into a fine part is used as a medium, a fatliquoring agent can be impregnated to a deep part of tissue and gaps between fibers and, once a fatliquoring agent is impregnated, unexpected detachment of a fatliquoring agent can be suitably prevented.

Further, since the present embodiment is provided with two high pressure cells of a high pressure cell 1a for accommodating a fatliquoring agent 22 and a high pressure cell 1b for accommodating a skin raw material 8, procedure of first removing impurities such as a resin component and water in the interior of hide or skin raw material 8 with supercritical carbon dioxide, and procedure of extracting a fatliquoring agent 22 can be performed in separate cells and, therefore, since after impurities such as a resin component and water in the interior of hide or skin raw material 8 are assuredly removed, supercritically extracted carbon dioxide can be injected into the interior of the skin raw material 8, a fatliquoring agent 22 can be more assuredly carried by a skin raw material 8.

(Embodiment 17)

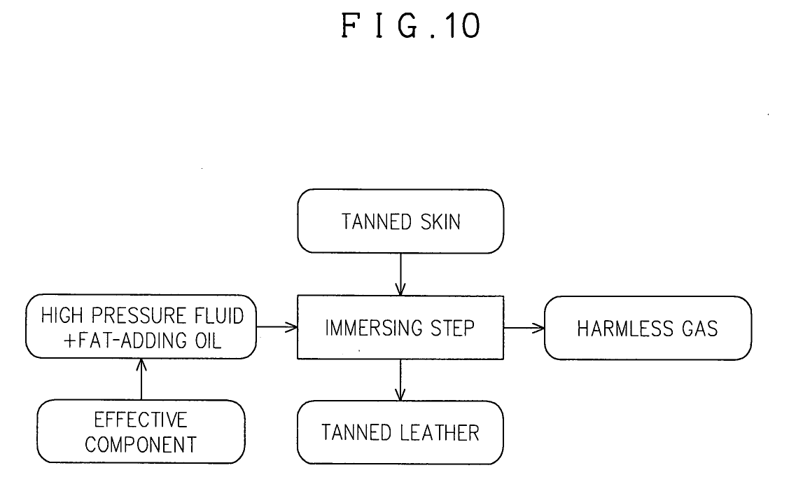

In the present embodiment, in a fat-adding step, a fatliquoring agent is added as in the embodiment 15 and an aromatic component is added different from addition of the fatliquoring agent, as shown in FIG. 10. As an apparatus, the same apparatus as that of embodiments 15 and 16 was used. Specifically, an essential oil such as components of peppermint, spearmint and Japanese Cyprus was used.

This aromatic component vanishes an odor as a deer skin and generates a new aromatic odor. As a result of addition of the aromatic component, there can be provided a leather product having a demand value also to consumers who dislike an odor of a deer skin.

(Embodiment 18)

In the present embodiment, a deodorant component was added in place of an aromatic component of the embodiment 17. As an apparatus, the same apparatus as that of embodiments 15 and 16 was used.

This deodorant component does not impart an aromatic flavor, but an odor of a deer skin could be vanished. As a result, there can be provided a leather product having a demand value also to consumers who dislike an odor of a deer skin.

(Embodiment 19)

In the present embodiment, a drug effective component was added in place of an aromatic component of the embodiment 17. Specifically, a herb extract such as lavender, Melissa, and lemon balm having sedative effect was produced, and was adhered to leather using the aforementioned supercritical fluid as a medium. In this case, by wearing a deer leather product after treatment, sedative effect is exerted and wet packing effect having action on a whole herb extract can be also expected. As an apparatus, the same apparatus as that of embodiments 15 and 16 was used.

(Embodiment 20)

In the present embodiment, an antibacterial component was added to leather in place of an aromatic component of the embodiment 17. Specifically, a natural antibacterial component extracted from catechin, bamboo, and bamboo grass was produced, and was adhered to leather using the aforementioned supercritical fluid as a medium. In this case, antibacterial effect can be manifested in a deer leather product itself, and a product can be kept hygienic over a long term.

(Embodiment 21)

In the present embodiment, an anti-mold component was added to leather in place of an aromatic component of the embodiment 17. As an apparatus, the same apparatus as that of embodiments 15 and 16 was used. Since by using a supercritical fluid as a medium, an anti-mold component is impregnated into the interior of hide or skin raw material, anti-mold effect can be maintained over a long term. In particular, since a natural raw material has low resistance to a mold, effect of being capable of maintaining anti-mold effect over a long term is extremely great for providing a leather product.

(Embodiment 22)

In the present embodiment, an insect-controlling component was added to a skin raw material in place of an aromatic component of the embodiment 17. As an apparatus, the same apparatus as that of embodiments 15 and 16 was used. Since by using a supercritical fluid as a medium, an insect-controlling component is impregnated into the interior of hide or skin raw material, insect-controlling effect can be maintained over a long term. Since a natural skin raw material has low insect-controlling effect, effect of being capable of maintaining insect-controlling effect over a long term is extremely great for providing a leather product.

(Embodiment 23)

In the present embodiment, a fatliquoring agent was injected using a cow skin as a skin raw material in place of a deer skin of embodiments 15 to 22. As an apparatus, the same apparatus as that of embodiments 15 and 16 was used.

Also in the present embodiment, since a supercritical fluid having a force of impregnating into a fine part is used as a medium, a fatliquoring agent can be injected to a deep part of tissue and gaps between fibers of a cow leather and, once a fatliquoring agent is added, unexpected detachment of a fatliquoring agent can be suitably prevented. In addition, since carbon dioxide is used as a supercritical fluid, a fat present between fibers of a cow leather is suitably removed due to a dissolving force and an extracting force of supercritical carbon dioxide for fat.

In addition to injection of a fatliquoring agent to a cow skin, an aromatic component, a deodorant component, a drug effective component, an antibacterial component, an anti-mold component, or an insect-controlling component can be added to a cow skin.

(Embodiment 24)

In the present embodiment, a fatliquoring agent was injected using a pig skin as a skin raw material in place of a deer skin of embodiments 15 to 22. As an apparatus, the same apparatus as that of embodiments 15 and 16 was used.

Also in the present embodiment, since a supercritical fluid having a force of impregnating into a fine part is used as a medium, an aromatic component can be added to a deep part of tissue and gaps between fibers of a pig skin and, after the addition, unexpected detachment of a fatliquoring agent can be suitably prevented and, moreover, since carbon dioxide is used as a supercritical fluid, a fat present between fibers of a pig skin is suitably removed due to a dissolving force and an extracting force of supercritical carbon dioxide for fat.

In addition to injection of a fatliquoring agent to a pig skin, an aromatic component, a deodorant component, a drug effective component, an antibacterial agent, an anti-molding component or an insect-controlling agent can be added to a pig skin.

(Embodiment 25)

In the present embodiment, a fatliquoring agent was injected using a sheep skin as a skin raw material in place of embodiments 15 to 22. As an apparatus, the same apparatus as that of embodiments 15 and 16 was used.

Also in the present embodiment, since a supercritical fluid having a force of impregnating into a fine part is used as a medium, a fatliquoring agent can be impregnated to a deep part of tissue and gaps between fibers of a sheep skin and, after impregnation, unexpected detachment of a fatliquoring agent can be suitably prevented and, moreover, since carbon dioxide was used as a supercritical fluid, a fat present between fibers of a sheep skin is suitably removed due to a dissolving force and an extracting force of supercritical carbon dioxide for fat.

In addition to injection of a fatliquoring agent into a sheep skin, an aromatic component, a deodorant component, a drug effective component, an antibacterial component, an anti-mold component, or an insect-controlling component can be added to a sheep skin.

(Other Embodiment)

Although as a medium for adding an effective component such as an aromatic component to leather, or as a medium for injecting a fatliquoring agent into a skin raw material, supercritical carbon dioxide was used in the aforementioned respective embodiments, so-called subcritical carbon dioxide having an operational temperature of a critical temperature or lower, or having an operational pressure of a critical pressure or lower, but having an operational temperature and an operational pressure near those critical temperature and critical pressure can be also used. Further, a high pressure fluid other than a supercritical fluid and a subcritical fluid other than carbon dioxide can be also used.

In addition, although supercritical carbon dioxide was used in the aforementioned embodiments, a supercritical fluid other than carbon dioxide, and a high pressure fluid such as a subcritical fluid other than carbon dioxide can be also used.

Further, in order to enhance effect of extracting respective components, a lower alcohol such as methanol, ethanol, and propanol, or an organic solvent such as n-hexane, acetone, and chloroform as a co-solvent can be also added at a minor amount of 1%, and 10% or less relative to a mole number of a supercritical fluid used. When a co-solvent is less than 1%, effect of extracting impurities such as fat contained in hide or skin raw material is small and, when a co-solvent is more than 10%, there is a possibility that a tissue itself of hide or skin raw material is deteriorated.

Further, as a kind of an aromatic component, various herb extracts such as mint, rosemary, and savanna can be used, or aromatic components other than herb extracts can be also used.

Further, a structure of an apparatus used is not limited to that of the aforementioned embodiments.

Further, as a leather product to be added, the present invention can be applied to various products such as a purse, a name card holder, a cap, a muffler, a shirt, a waistcoat, a vest, a jacket, a jumper, a coat, a trouser, an under pant, a glove, a shoe, a portfolio, a bag, a pouch, a key holder, strap for mobile phone, a suspender, a toy, and a stationery.

In addition, the present invention can be also applied to a fur product such as a coat, a comforter, an accessory in addition to leather products. Further, the present invention can be also applied to furs for mounted animals and birds in addition to the clothings and ornaments. When applied to furs, furs obtained by processing by leaving a hair or a feather without exposing a grain side naturally utilized.

Further, kinds of leather and a leather raw material are not limited to leathers of a deer, a cow, a pig, a sheep, an alligator, a snake, and an orchard, and furs of a rabbit of the aforementioned respective embodiments, but leathers and skin raw materials of a mink, a chinchilla, a mole, a fox, a weasel, a camel, a kangaroo, a reindeer, a moose, a lizard and an emu can be also used.

Although a fatliquoring agent is extracted with a high pressure fluid such as a supercritical fluid, and is impregnated into a skin raw material in a fat-adding step in embodiments 15 to 25, a fat or oil component may be impregnated into a skin raw material in a step other than a fat-adding step. For example, a synthetic oil component used as a tanning agent may be extracted with a high pressure fluid such as a supercritical fluid and may be impregnated into a skin raw material in a tanning step. In summary, it is enough that a fat or oil component together with a high pressure fluid is impregnated into a skin raw material.

In addition, although embodiments 17 to 25 explained the case where an aromatic component, a deodorant component, a drug effective component, an antibacterial component, an anti-mold component, or an insect-controlling component together with a fatliquoring agent is added in a fat-adding step, these components may be added at a step other than a fat-adding step. For example, an aromatic component, a deodorant component, a drug effective component, an antibacterial component, an anti-mold component or an insect-controlling component can be added to leather obtained via a drying step after a fat-adding step using a high pressure fluid, or an aromatic component, a deodorant component, a drug effective component, an antibacterial component, an anti-mold component, or an insect-controlling component can be added using a high pressure fluid after these steps, and after processed into a desired shape of each leather product. Like this, when these components are added at a step other than a fat-adding step, it becomes necessary to perform separately procedure of impregnating these components into leather with a high pressure fluid, and procedure of impregnating a fatliquoring agent into leather with a high pressure fluid in a fat-adding step.

### EXAMPLES

Examples of the present invention will be explained below.

Examples 1 to 9 are an example of adding an aromatic component, and Examples 10 to 13 are an example of adding a fatliquoring agent and adding an aromatic component.

### Example 1

15 g of a deer leather sample was disposed in a high pressure cell having a volume of 300 ml, liquid carbon dioxide was introduced into a high pressure cell with a high pressure pump, and retained at a pressure of 20 MPa and a temperature of 40° C. for 3 hours and, thereafter, carbon dioxide was flown for 3 hours at a rate of 1.5 L/min. A rate of carbon dioxide is a flow rate per unit time at room temperature under an atmospheric pressure, and the rate was measured using an integrating flowmeter. An efflux fluid was cooled to trap to obtain a colored extract. Subsequently, the extract was treated in high pressure carbon dioxide for 4 hours, and pressure was reduced to an atmospheric pressure using a back pressure valve. Leather was completely dried. Test conditions and change in a weight of leather before and after a test are shown in Table 1.

TABLE 1
(High pressure fluid drying treatment test of various treated leathers)

| | | | Sample | Weight | | |
|---|---|---|---|---|---|---|
| | Retention | Flowing | weight | after | Extracted | Drying |
| Sample | time (hr) | time (hr) | (g) | drying (g) | amount (g) | rate (%) |
| Raw material | 3 | 3 | 3.25 | 2.88 | 0.37 | 11.4 |
| white leather | | | | | | |
| S1 | | | | | | |
| Tannin-treated | 3 | 3 | 4.94 | 4.33 | 0.61 | 12.3 |
| leather S2 | | | | | | |
| Chromium | 3 | 3 | 4.45 | 3.94 | 0.51 | 11.5 |
| brown-stained | | | | | | |
| leather S3 | | | | | | |
| Chromium | 3 | 3 | 4.78 | 4.38 | 0.40 | 7.1 |
| black-stained | | | | | | |
| leather S4 | | | | | | |
| Raw material | 3 | 3 | 5.63 | 4.81 | 0.82 | 14.6 |
| white-stained | | | | | | |
| leather S5 | | | | | | |

As is clear from from the above mentioned Table 1, a drying rate in high pressure carbon dioxide was around 7 to 15% (abbreviated as wt % in the following Examples) in terms of a weight. A component of the extract was mainly a fat. Therefore, it was confirmed that a fat was suitably removed.

Then, a pressure in a high pressure cell with this dried leather disposed therein was further reduced with a vacuum pump, and 0.3 ml of savanna (natural herb essential oil manufactured by Global.P.p) as an aromatic component was filled into a high pressure cell by suction. Thereafter, high pressure carbon dioxide was introduced, this was retained at 20 MPa and 40° C. for 3 hours, a pressure was reduced to an atmospheric pressure over 2 hours using a back pressure valve, and leather was removed and, as a result, the leather had a strong odor. The test conditions and change in a weight are shown in Table 2.

TABLE 2
(Flavoring test of various leathers with high pressure fluid)

| | | | Increased |
|---|---|---|---|
| | Retention | Flowing | Sample |
| Sample | time (hr) | time (hr) | weight (g) |
| Raw material white | 3 | 2 | 0.02 |
| leather S1 | | | |
| Tannin-treated | 3 | 2 | 0.03 |
| leather S2 | | | |
| Chromium | 3 | 2 | 0.18 |
| brown-stained | | | |
| leather S3 | | | |
| Chromium | 3 | 2 | 0.22 |
| black-stained | | | |
| leather S4 | | | |
| Raw material | 3 | 2 | 0.01 |
| white-stained | | | |
| leather S5 | | | |

As apparent from Table 2, in a flavoring step, slight increase in a weight was recognized. From them, it was presumed that a fat was suitably removed from leather, and an aromatic component was suitably injected.

Then, the resulting leathers were subjected to various physical property tests. That is, regarding a raw material leather and a tanning-treated and stained leather, specifically, a raw material deer white leather (S1), a tanning-treated deer leather (S2), a chromium-tanned brown-stained leather (S3), a chromium-tanned and black-stained leather (S4), and a white-stained leather (S5) obtained by white-staining a raw material deer white leather, physical tests such as a tensile strength, an elongation, a tearing strength, and an in liquid thermal shrinkage temperature were performed, and a fastness test such as staining abrasion fastness, and washing fastness was performed. Results are shown in Table 3, and Table 4. As apparent from Table 3 and Table 4, regarding a tensile strength, an elongation, a tearing strength, an in liquid thermal shrinkage temperature, staining abrasion fastness, washing fastness and the like after extraction and flavoring treatment, reduction in physical properties was not recognized and, regarding almost of leathers, better properties are maintained, and function of aromatic effect could be imparted without deteriorating properties possessed by leather.

TABLE 3
(Various effect tests)

| | Item | | | | | | | | | |
|---|---|---|---|---|---|---|---|---|---|---|
| | | | | | Chromium | | Chromium | | | |
| | Raw material white | | Tannin-treated | | brown-stained | | black-stained | | Raw material white | |
| | leather S1 | | leather S2 | | leather S3 | | leather S4 | | stained leather S5 | |
| Completion | Incomple- | Comple- | Incomple- | Comple- | Incomple- | Comple- | Incomple- | Comple- | Incomple- | Comple- |
| or | tion | tion | tion | tion | tion | tion | tion | tion | tion | tion |
| incompletion | | | | | | | | | | |
| of flavoring | | | | | | | | | | |
| treatment | | | | | | | | | | |
| In liquid | — | — | — | — | 109 | 110 | 101 | 100 | — | — |
| thermal | | | | | | | | | | |
| shrinkage | | | | | | | | | | |
| temperature | | | | | | | | | | |
| (° C.) [Before | | | | | | | | | | |
| washing] | | | | | | | | | | |
| In liquid | — | — | — | — | 100 | 100 | 95 | 95 | — | — |
| thermal | | | | | | | | | | |
| shrinkage | | | | | | | | | | |
| temperature | | | | | | | | | | |
| (° C.) [After | | | | | | | | | | |
| washing] | | | | | | | | | | |
| Tensile | 17 | 24 | 23 | 15 | 17 | 17 | 17 | 9 | 32 | 34 |
| strength | | | | | | | | | | |
| (MPa) | | | | | | | | | | |
| Elongation | 75 | 73 | 76 | 73 | 84 | 81 | 96 | 80 | 86 | 94 |
| (%) | | | | | | | | | | |
| Tearing | 21 | 26 | 29 | 25 | 21 | 18 | 25 | 18 | 29 | 36 |
| strength | | | | | | | | | | |
| (N/mm) | | | | | | | | | | |

TABLE 4
(Fastness test)

| | | | Item | | | |
|---|---|---|---|---|---|---|
| | | | Chromium | | | |
| | | | brown-stained leather | | Chromium | |
| | | | S3 | | black-stained leather S4 | |
| Completion or incompletion of | | | Incompletion | Completion | Incompletion | Completion |
| flavoring treatment | | | | | | |
| Staining | Drying | Changing | 4-5 | 4-5 | 4-5 | 4-5 |
| abrasion | | and | | | | |
| fastness | | fading in | | | | |
| (class) | | color | | | | |
| | | Pollution | 4 | 4 | 4 | 4 |
| | Wetting | Changing | 4 | 4 | 4 | 4 |
| | | and | | | | |
| | | fading in | | | | |
| | | color | | | | |
| | | Pollution | 3-4 | 3-4 | 4 | 4 |
| | Sweat | Changing | 4 | 4 | 4 | 4 |
| | test | and | | | | |
| | (acidic) | fading in | | | | |
| | | color | | | | |
| | | Pollution | 3-4 | 3-4 | 4 | 3-4 |
| | Sweat | Changing | 4 | 4 | 4 | 4 |
| | test | and | | | | |
| | (alkaline) | fading in | | | | |
| | | color | | | | |
| | | Pollution | 3-4 | 3-4 | 4 | 3-4 |
| Washing | Wet | Changing | 3 | 3-4 | 4 | 4 |
| fastness | cleaning | and | | | | |
| (class) | | fading in | | | | |
| | | color | | | | |
| | | Pollution | 4 | 4 | 4 | 4 |

### Example 2

15 g of a deer leather sample was disposed in a high pressure cell having a volume of 300 ml, liquified carbon dioxide was introduced into a high pressure cell with a high pressure pump, retained at a pressure of 20 MPa and a temperature of 40° C. for 2 hours and, thereafter, carbon dioxide was flown for 3 hours at rate of 1.5 L/min to remove leather, to completely dry leather. A rate of carbon dioxide is a flow rate per unit time of carbon dioxide at room temperature under an atmospheric pressure, and the rate was measured using an integrating flowmeter.

Then, this dried leather, and 0.3 ml of rosemary (natural herb essential oil manufactured by Global P.P.) as an aromatic component were filled into a high pressure cell.

Then, supercritical carbon dioxide was introduced, retained at 20 MPa of 40° C. for 3 hours, and supercritical carbon dioxide was flown for 2 hours while retaining the same temperature and the same pressure. After treatment, a pressure was reduced to an atmospheric pressure using a back pressure valve, a leather product was removed and, as a result, the leather product had a strong odor.

### Example 3

15 g of a cow leather which is a raw material was disposed in a high pressure cell, liquified carbon dioxide was introduced into a high pressure cell with a high pressure pump, retained at a pressure of 20 MPa and a temperature of 40° C. for 1 hour and, thereafter, carbon dioxide was flown for 4 hours at a rate of 1.5 L/min. A rate of carbon dioxide is a flow rate per unit time of carbon dioxide at room temperature under an atmospheric pressure, and the rate was measured using an integrating flowmeter. Subsequently, a pressure was reduced back to an atmospheric pressure via a back pressure valve. Change in a weight of leather before and after a test, and an amount of an extracted and removed component in a drying step are shown in Table 5.

TABLE 5
(High pressure fluid drying treatment test of various leather materials)

| | Retention | Flowing | Sample | Weight after | Extracted | Drying |
|---|---|---|---|---|---|---|
| Sample | time (hr) | time (hr) | weight (g) | drying (g) | amount (g) | rate (%) |
| Cow | 1 | 4 | 13.62 | 12.61 | 1.01 | 7.4 |
| Pig | 1 | 4 | 24.93 | 21.73 | 3.20 | 12.8 |
| Sheep | 1 | 4 | 14.68 | 13.17 | 1.51 | 10.3 |
| Alligator | 1 | 4 | 46.75 | 43.81 | 2.94 | 6.3 |
| Snake | 1 | 4 | 37.94 | 36.23 | 1.71 | 4.5 |
| Orchard | 1 | 4 | 81.26 | 78.05 | 3.21 | 4.0 |
| Rabbit | 1 | 4 | 41.98 | 40.42 | 1.56 | 3.7 |

As apparent from Table 5, a drying rate in supercritical carbon dioxide was 7.4 wt %. A component of the extract was mainly a fat. Therefore, it was confirmed that a fat was suitably removed.

Then, a raw material of an aromatic component together with leather after drying was disposed in a high pressure cell having a volume of 300 ml, liquified carbon dioxide was introduced into a high pressure cell with a high pressure pump, retained at a pressure of 20 MPa and a temperature of 40° C. for 3 hours, and a pressure was reduced back to an atmospheric pressure over 2 hours via a back pressure valve. As a component of a flavor raw material, sweet orange (rind-squeezed essential oil manufactured by Sunfirm Shoji) was used as shown in the following Table 6, and a charging amount was 1.0 g.

TABLE 6
(Flavor component and charging amount)

| | | Charging amount |
|---|---|---|
| Sample | Flavor component | (g) |
| Cow | Sweet orange | 1.0 |
| Pig | Sweet orange | 1.0 |
| Sheep | Sweet orange | 1.0 |
| Alligator | Rosemary | 0.8 |
| Snake | Rosemary | 0.8 |
| Orchard | Japanese Cyprus | 1.0 |
| Rabbit | Japanese Cyprus | 1.0 |

Change in a weight of each leather before and after a test is shown in Table 7.

TABLE 7
(Flavoring test of various leathers with high pressure fluid)

| | Retention | Flowing | Sample | Weight after | Addition | Adhesion |
|---|---|---|---|---|---|---|
| Sample | time (hr) | time (hr) | weight (g) | flavoring (g) | amount (g) | rate (%) |
| Cow | 3 | 2 | 12.61 | 12.72 | 0.11 | 0.9 |
| Pig | 3 | 2 | 21.73 | 21.83 | 0.10 | 0.5 |
| Sheep | 3 | 2 | 13.17 | 13.21 | 0.04 | 0.3 |
| Alligator | 3 | 2 | 43.81 | 44.33 | 0.52 | 1.2 |
| Snake | 3 | 2 | 36.23 | 36.47 | 0.24 | 0.7 |
| Orchard | 3 | 2 | 78.05 | 78.06 | 0.01 | 0.1 |
| Rabbit | 3 | 2 | 40.42 | 40.60 | 0.18 | 0.4 |

As apparent from Table 7, increase in a weight, that is, an addition amount in a flavoring step was 0.11 g, and an adhesion rate was 0.9 wt %. From this, it is presumed that an aromatic component was suitably injected into leather of a cow leather.

Then, regarding the resulting leathers, various physical property tests, that is, tests of a tensile strength, an elongation, a tearing strength, an in liquid thermal shrinkage temperature and the like were performed, and a fastness test such as stain abrasion fastness and ,washing fastness was further performed. The test results are shown in Table 8 and Table 9.

As apparent from Table 8 and Table 9, regarding various physical properties such as an elongation, a tearing strength, and an in liquid thermal shrinkage, and fastness such as stain abrasion fastness and washing fastness after extraction and flavoring treatment, reduction was not recognized, better properties were maintained, and function of aromatic effect could be imparted without deteriorating property possessed by leather.

On the other hand, regarding a tensile strength, improvement was recognized after treatment.

TABLE 8
(Various physical property tests)

| | Item | | | | | |
|---|---|---|---|---|---|---|
| | Cow leather | | Pig leather (Beccary) | | Sheep leather | |
| Completion | Incompletion | Completion | Incompletion | Completion | Incompletion | Completion |
| or | | | | | | |
| incompletion | | | | | | |
| of flavoring | | | | | | |
| treatment | | | | | | |
| In liquid | 106 | 108 | 107 | 104 | 103 | 11 |
| thermal | | | | | | |
| shrinkage | | | | | | |
| temperature | | | | | | |
| (° C.) [Before | | | | | | |
| washing] | | | | | | |
| In liquid | 100 | 108 | 105 | 112 | 96 | 11 |
| thermal | | | | | | |
| shrinkage | | | | | | |
| temperature | | | | | | |
| (° C.) [After | | | | | | |
| washing] | | | | | | |
| Tensile | 7 | 12 | 19 | 20 | 13 | 9 |
| strength | | | | | | |
| (MPa) | | | | | | |
| Elongation | 40 | 40 | 67 | 93 | 89 | 56 |
| (%) | | | | | | |
| Tearing | 14 | 15 | 34 | 45 | 29 | 75 |
| strength | | | | | | |
| (N/mm) | | | | | | |

TABLE 9
(Fastness test)

| | | | Item | | | | | |
|---|---|---|---|---|---|---|---|---|
| | | | Cow leather | | Pig leather (Beccary) | | Sheep leather | |
| Completion or incompletion of | | | Incompletion | Completion | Incompletion | Completion | Incompletion | Completion |
| flavoring treatment | | | | | | | | |
| Staining | Drying | Changing | 4-5 | 4 | — | — | 4 | 4 |
| abrasion | | and fading | | | | | | |
| fastness | | in color | | | | | | |
| (class) | | Pollution | 4 | 4 | — | — | 3 | 4-5 |
| | Wetting | Changing | 4-5 | 4-5 | — | — | 4-5 | 4 |
| | | and fading | | | | | | |
| | | in color | | | | | | |
| | | Pollution | 3 | 3-4 | — | — | 4 | 4 |
| | Sweat | Changing | 4-5 | 4-5 | — | — | 4 | 4 |
| | test | and fading | | | | | | |
| | (acidic) | in color | | | | | | |
| | | Pollution | 2-3 | 3 | — | — | 3-4 | 3-4 |
| | Sweat | Changing | 4-5 | 4 | — | — | 4 | 4 |
| | test | and fading | | | | | | |
| | (alkaline) | in color | | | | | | |
| | | Pollution | 2 | 2-3 | — | — | 3 | 3 |
| Washing | Wet | Changing | 4-5 | 4 | 4 | 4 | 4-5 | 4 |
| fastness | cleaning | and fading | | | | | | |
| (class) | | in color | | | | | | |
| | | Pollution | 2-3 | 2-3 | 4-5 | 4-5 | 3-4 | 3-4 |

### Example 4

Regarding 15 g of a pig leather sample, extraction treatment was performed using the same apparatus as that of Example 3 under the same conditions. Change in a weight of leather before and after a test, and an amount of an extracted and removed component in a drying step are shown in the aforementioned Table 5.

Apparent from Table 5, a drying rate in supercritical carbon dioxide was as high as 12.8%. A component of the extract was mainly a fat. Therefore, it was confirmed that a fat was suitably removed.

In addition, after extraction treatment, flavoring treatment was performed using the same apparatus as that of Example 3 under the same conditions. As a component of a flavor raw material, sweet orange was used as in Example 3, and a charging amount was 1.0 g.

Change in a weight of each leather before and after a test is shown in the above Table 7.

As apparent from above Table 7, increase in a weight, that is, an addition amount in a flavoring step was 0.01 g, and an adhesion rate was 0.5 wt %. From this, it is presumed that an aromatic component was suitably injected into leather of pig leather.

Then, regarding the resulting flavored leathers, various physical property tests, that is, tests of a tensile strength, an elongation, a tearing strength, an in liquid thermal shrinkage temperature and the like were performed, and a washing fastness test was further performed. The test results are shown in the above Table 7 and Table 8.

As is clear from the above mentioned Table 7 and Table 8, regarding various physical properties such as a tensile strength, and an in liquid thermal shrinkage temperature, and washing fastness after extraction and flavoring treatment, reduction is not recognized, better property is maintained and, function of aromatic effect could be imparted without deteriorating property possessed by leather.

On the other hand, regarding a tearing strength, improvement is recognized after treatment and, regarding an elongation, a remarkable improvement was recognized after treatment.

### Example 5

Regarding 15 g of a sheep leather sample, extraction treatment was performed using the same apparatus as that of Example 3 under the same conditions. Change in a weight of leather before and after test, and an amount of an extracted and removed component in a drying step are shown in the above Table 5.

As apparent from above Table 5, a drying rate in supercritical carbon dioxide was as high as 10.3%. A component of the extract was mainly a fat. Therefore, it was confirmed that a fat was suitably removed.

In addition, after extraction treatment, flavoring treatment was performed using the same apparatus as that of Example 3 under the same conditions. As a component of a flavor raw material, sweet orange was used as in Example 3, and a charging amount was 1.0 g.

Change in a weight of each leather before and after a test is shown in the above Table 7.

As apparent from above Table 7, increase in a weight, that is, an addition amount in a flavoring step was 0.04 g, and an adhesion rate was 0.3 wt %. From this, it is presumed that an aromatic component was suitably injected into leather of sheep leather.

Then, regarding the resulting leathers, various physical property tests, that is, tests of a tensile strength, an elongation, a tearing strength, an in liquid thermal shrinkage temperature and the like were performed, and a fastness test such as staining abrasion fastness and washing fastness was further performed. The test results are shown in Table 8 and Table 9.

As is clear from the above mentioned Table 8 and Table 9, regarding an in liquid thermal shrinkage temperature, and fastness such as staining abrasion fastness and washing fastness after extraction and flavoring treatment, reduction was not recognized, better property was maintained, and function of aromatic effect could be imparted without deteriorating property possessed by leather.

On the other hand, regarding a tensile strength and an elongation, slight reduction was recognized, but regarding a tearing strength, remarkable improvement was recognized.

### Example 6

Regarding 15 g of an alligator leather sample, extraction treatment was performed using the same apparatus as that of Example 3 under the same conditions. Change in a weight of leather before and after a test, and an amount of an extracted and removed component in a drying step are shown in the above Table 5.

As apparent from the Table 5, a drying rate in supercritical carbon dioxide was 6.3 wt %. A component of the extract was mainly a fat. Therefore, it was confirmed that a fat was suitably removed.

In addition, after extraction treatment, flavoring treatment was performed using the same apparatus as that of Example 3 under the same conditions. As a component of a flavor raw material, rosemary (natural herb essential oil manufactured by Global.P.P.) was used as show in the above Table 6, and a charging amount was 0.8 g.

Change in a weight of each leather before and after a test is shown in above Table 7.

As apparent from above Table 7, increase in a weight, that is, an addition amount in flavoring step was 0.52 g, and an adhesion rate was 1.2 wt %. From this, it is presumed that a flavor component was suitably injected into leather of an alligator leather.

Then, regarding the resulting leathers, various physical property tests, that is, tests of a tensile strength, an elongation, a tearing strength, an in liquid thermal shrinkage temperature and the like were performed, and a washing fastness test was further performed. The test results are shown in Table 10 and Table 11.

TABLE 10
(Various physical property tests)

| | Item | | | | | | | |
|---|---|---|---|---|---|---|---|---|
| | Alligator leather | | Snake leather | | Orchard leather | | Rabbit fur | |
| Completion or | Incompletion | Completion | Incompletion | Completion | Incompletion | Completion | Incompletion | Completion |
| incompletion of | | | | | | | | |
| flavoring | | | | | | | | |
| treatment | | | | | | | | |
| In liquid | 105 | 105 | 79 | 82 | 110 | 110 | 40 | 40 |
| thermal | | | | | | | | |
| shrinkage | | | | | | | | |
| temperature | | | | | | | | |
| (° C.) [Before | | | | | | | | |
| washing] | | | | | | | | |
| In liquid | 105 | 106 | 79 | 79 | 106 | 106 | — | — |
| thermal | | | | | | | | |
| shrinkage | | | | | | | | |
| temperature | | | | | | | | |
| (° C.) [After | | | | | | | | |
| washing] | | | | | | | | |
| Tensile | 3 | 15 | 5 | 6 | 21 | 12 | 3 | 5 |
| strength (MPa) | | | | | | | | |
| Elongation (%) | 18 | 43 | 20 | 20 | 54 | 57 | 36 | 36 |
| Tearing | 15 | 20 | 11 | 12 | 17 | 37 | 2 | 3 |
| strength | | | | | | | | |
| (N/mm) | | | | | | | | |

TABLE 11
(Washing fastness test: wet cleaning [class])

| | Item | | | | | | | |
|---|---|---|---|---|---|---|---|---|
| | Alligator | | Snake | | Orchard | | Rabbit | |
| | leather | | leather | | leather | | fur | |
| Changing | 4-5 | 4-5 | 4-5 | 4-5 | 4-5 | 4-5 | 4-5 | 4-5 |
| or fading | | | | | | | | |
| in color | | | | | | | | |
| Pollution | 4-5 | 4-5 | 4-5 | 4-5 | 4 | 4 | 4-5 | 4-5 |

As apparent from Table 10 and Table 11, regarding an in liquid thermal shrinkage temperature and washing fastness after extraction and flavoring treatment, reduction was not recognized, better effects were maintained, and function of aromatic effect could be imparted without deteriorating property possessed by leather. On the other hand, regarding a tearing strength, slight improvement was recognized, but regarding a tensile strength and an elongation, remarkable improvement was recognized.

### Example 7

Regarding 15 g of a snake leather sample, extraction treatment was performed using the same apparatus as that of Example 3 under the same conditions. Change in a weight of leather before and after a test, and an amount of an extracted and removed component in a drying step are shown in the above Table 5.

As apparent in the above Table 5, a drying rate in supercritical carbon dioxide was 4.5 wt %. A component of the extract was mainly a fat. Therefore, it was confirmed that a fat was suitably removed.

In addition, after extraction treatment, flavoring treatment was performed using the same apparatus as that of Example 3 under the same conditions. As a raw material of an aromatic component, rosemary was used as in Example 6, and a charging amount was 0.8 g.

Change in a weight of each leather before and after a test is shown in the above Table 7.

As is clear from the above mentioned Table 7, increase in a weight, that is, an addition amount in a flavoring step was 0.24 g, and an adhesion rate was 0.7 wt %. From this, it is presumed that a flavor component was suitably injected into leather of a snake leather.

Then, regarding the resulting leathers, various physical property tests, that is, tests of a tensile strength, an elongation, a tearing strength, an in liquid thermal shrinkage temperature and the like were preformed, and a washing fastness test was further performed. The test results are shown in the above Table 10 and Table 11.

As is clear from the above mentioned Table 10 and Table 11, regarding any physical properties after extraction and flavoring treatment, reduction is not recognized, better effects are maintained, and function of aromatic effect could be imparted without deteriorating property possessed by leather.

### Example 8

Regarding 15 g of an orchard leather sample, extraction treatment was performed using the same apparatus as that of Example 3 under the same conditions. Change in a weight of leather before and after a test, and an amount of an extracted and removed component in a drying step are shown in the Table 5.

As is clear from the above mentioned Table 5, a drying rate in supercritical carbon dioxide was 4.0 wt %. A component of the extract was mainly a fat. Therefore, it was confirmed that a fat was suitably removed.

In addition, after extraction treatment, flavoring treatment was performed using the same apparatus as that of Example 3 under the same conditions. As a component of a flavor raw material, a flavor component of Japanese Cyprus (natural essential oil manufactured by Sunfirm shoji) was used as shown in the above Table 6, and a charging amount was 1.0 g.

Change in a weight of each leather before and after a test is shown in the above Table 7.

As is clear from the above mentioned Table 7, increase in a weight, that is, an addition amount in a flavoring step was 0.01 g, and an adhesion rate was 0.1 wt %. An addition amount was small as compared with other leathers, but it is presumed that a flavor component was in fact injected also in leather of an orchard leather.

Then, regarding the resulting materials, various physical property tests, that is, tests of a tensile strength, an elongation, a tearing strength, an in liquid thermal shrinkage temperature and the like were performed, and a washing fastness test was further performed. The test results are shown in the above Table 10 and Table 11.

As is clear from the above mentioned Table 10 and Table 11, regarding respective physical properties of an elongation and an in liquid thermal shrinkage temperature, and washing fastness after extraction and flavoring treatment, reduction is not recognized, better effects are maintained, and function of aromatic effect could be imparted without deteriorating property possessed by leather.

On the other hand, regarding a tensile strength, slight reduction was recognized, but regarding a tensile strength, remarkable improvement was recognized.

### Example 9

Regarding 15 g of a rabbit fur sample, extraction treatment was performed using the same apparatus as that of Example 3 under the same conditions. Change in a weight of leather before and after a test, and an amount of an extracted and removed component in a drying step are shown in the above Table 5.

As is clear from the above mentioned Table 5, a drying rate in supercritical carbon dioxide was 3.7 wt %. A component of the extract was mainly a fat. Therefore, it was confirmed that fat was suitably removed.

In addition, after extraction treatment, flavoring treatment was performed using the same apparatus as that of Example 3 under the same conditions. As a component of a flavor raw material, a flavor component of Japanese Cyprus was used as in Example 8, and a charging amount was 1.0 g.

Change in a weight of each fur before and after a test is shown in the above Table 7.

As is clear from the above mentioned Table 7, increase in a weight, that is, an addition amount in a flavoring step was 0.18 g, and an adhesion rate was 0.4 wt %. From this, it is presumed that a flavor component was suitably injected into a rabbit fur.

Then, regarding the resulting furs, various physical property tests, that is, tests of a tensile strength, an elongation, a tearing strength, an in liquid thermal shrinkage temperature and the like were performed, and a washing fastness test was further performed. The test results are shown in the above Table 10 and Table 11.

As is clear from Table 10 and Table 11, regarding respective physical properties of an elongation and an in liquid thermal shrinkage temperature, and washing fastness after extraction and flavoring treatment, reduction is not recognized, better effects are maintained, and function of aromatic effect could be imparted without deteriorating property possessed by fur.

On the other hand, regarding a tensile strength and a tearing strength, slight improvement was recognized.

### Example 10

The present Example is an example of injecting a fatliquoring agent. As a preparation apparatus, the apparatus shown in the embodiment 15 was used. First, initially, in order to enhance an efficacy of injecting a fatliquoring agent, a drying step of removing impurities remaining in a skin raw material was performed. As a procedural method, 15 g of a raw material deer skin sample was disposed in a high pressure cell having a volume of 500 ml, liquefied carbon dioxide was introduced into a high pressure cell with a high pressure pump, retained at a pressure of 20 MPa and a temperature of 40° C. for 3 hours and, thereafter, carbon dioxide was flown for 3 hours at a rate of 1.5 L/min. A rate of carbon dioxide is a flow rate per unit time of carbon dioxide at room temperature under an atmospheric pressure, and the rate was measured using an integrating flowmeter. An efflux fluid was cooled to trap, to obtain a colored extract. Subsequently, the extract was treated in supercritical carbon dioxide for 4 hours, and a pressure was reduced to an atmospheric pressure using a back pressure valve. A skin raw material was completely dried. A drying rate in supercritical carbon dioxide was about 7 to 15% (abbreviated as wt % in the following Examples) in terms of a weight. A component of the extract was mainly a fat. Therefore, it was confirmed that a fat as impurities remaining in skin raw material was suitably removed.

Then, a pressure of a high pressure cell with this dried skin raw material disposed therein was reduced with a vacuum pump, and 2 ml of Sincholine M manufactured by Nippon Seika Co., Ltd. as a fatliquoring agent, and 0.3 ml of savanna (natural herb essential oil manufactured by Global P.P.) as an aromatic component were disposed in a high pressure cell by suction. Thereafter, supercritical carbon dioxide was introduced, retained at 20 MPa and 40° C. for 3 hours, a pressure was reduced to an atmospheric pressure over 2 hours using a back pressure valve, and a skin raw material was removed and, as a result, a skin regained flexibility, and had a herb odor. Consequently, a weight was increased by 5 wt %. Apparent from this result, it is presumed that a fatliquoring agent and a flavor component were preferably injected.

The above Sincholine M is a pale-colored anionic fatliquoring agent containing a sulfonated synthetic oil as a main component, and has a pH of 6.5 to 7.0.

### Example 11

15 g of a cow leather sample was disposed in a high pressure cell having a volume of 500 ml, liquifide carbon dioxide was introduced into a high pressure cell using a high pressure pump, retained at a pressure of 20 MPa and a temperature of 40° C. for 1 hour and, thereafter, carbon dioxide was flown for 4 hours at a rate of 1.5 L/min. A rate of carbon dioxide is a flow rate per unit time of carbon dioxide at room temperature under an atmospheric pressure, and the rate was measured using an integrating flowmeter. Subsequently, a pressure was reduced back to an atmospheric pressure via a back pressure valve. Reduction in a weight of hide or skin raw material before and after a test was 7.4 wt %. A component of the extract was mainly a fat. Also in the present Example, it was confirmed that a fat as impurities was suitably removed by performing a drying step.

Then, a fatliquoring agent and a flavor raw material together with leather after drying were disposed in a high pressure cell having a volume of 500 ml, liqiufied carbon dioxide was introduced into a high pressure cell using a high pressure pump, retained at a pressure of 20 MPa and a temperature of 40° C. for 3 hours and, thereafter, a pressure was reduced back to an atmospheric pressure over 2 hours using a back pressure valve. As a fatliquoring agent, 2 ml of Sincholine M manufactured by Nippon Seika Co., Ltd. was used and, as an aromatic component, sweet orange (rind-squeezed essential oil manufactured by Sunfirm Shoji) was used, and a charging amount was 1.0 g.

Increase in a weight, that is, an adhesion rate after treatment was about 4 wt %, and a herb odor was imparted. From this, it is presumed that a fatliquoring agent and a flavor component were suitably injected also in a cow leather.

### Example 12

15 g of a pig leather sample was treated using the same apparatus as that of Example 10 under the same conditions. A drying rate in supercritical carbon dioxide was as high as 12.8%. A component of the extract was mainly a fat. Also in the present Example, it was confirmed that a fat as impurities was suitably removed by performing a drying step.

In addition, after extraction treatment, treatment was performed using the same apparatus as that of Example 10 under the same conditions. As a fatliquoring agent, 2 ml of Sincholine M manufactured by Nippon Seika Co., Ltd. was used and, as a component of a flavor raw material, sweet orange was used as in Example 2, and a charging amount was 1.0 g. Increase in a weight, that is, an addition rate after treatment was about 6 wt %. Further, it was confirmed that a herb odor was imparted. From this, it is presumed that a fatliquoring agent and a flavor component were suitably injected also into a pig skin.

### Example 13

15 g of a sheep skin sample was treated using the same apparatus as that of Example 10 under the same conditions. A drying rate of hide or skin raw material before and after a test was as high as 10.3%. A component of the extract was mainly a fat. Also in the present Example, it is confirmed that a fat as impurities was suitably removed by performing a drying step. In addition, after extraction treatment, flavoring treatment was performed using the same apparatus as that of Example 2 under the same conditions. As a fatliquoring agent, 2 ml of Sincholine M manufactured by Nippon Seika Co., Ltd. was used and, as a component of a flavor raw material, sweet orange was used as in Example 2, and a charging amount was 1.0 g.

Increase in a weight of each leather before and after a test was about 4 wt %, and a herb odor was imparted. From this, it is presumed that a fatliquoring agent and a flavor component were suitably injected into a sheep skin.

### Other Example

Although the case of imparting an aromatic component was explained in Examples 1 to 9, it is possible to impart an effective component having deodorant effect, drug effect, antibacterial effect, anti-mold effect or insect-controlling effect, being not limited to an aromatic component.

In addition, although as a fatliquoring agent, Sincholine M manufactured by Nippon Seika Co., Ltd. was used in Examples 10 to 13, a kind of a fatliquoring agent is not limited to this, but Sincholine L, Sincholine Z-2, Aniol SS and the like manufactured by the same company can be also used. In particular, when Aniol SS is used together with Sincholine L, Sincholine L, or Sincholine Z-2, better effect can be obtained in plump effect, flexibility and skin touch of leather. Aniol SS is a pale yellow pasty synthetic fatliquoring agent obtained by anionizing a fat substance, and has a pH 6.5 to 7.0.

In addition, as a product of other company, for example, commercially available synthetic fatliquoring agents for an animal skin, such as a chlorinated and sulfochlorinated product of a paraffin hydrocarbon, synthetic fatty acid ester and ester oil, mineral oil and other petroleum chemical products may be used.

1. A material to be processed into leather products such as leather and fur comprising any one of at least one effective component of an aromatic component, a deodorant component, a drug effective component, an antibacterial component, an anti-mold component and an insect-controlling component, and a fat or oil component such as a fatliquoring agent, impregnated into tissue and fiber of animal hide or skin using a high pressure fluid as a medium.

2. A leather product such as leather and fur comprising any one of at least one effective component of an aromatic component, a deodorant component, a drug effective component, an antibacterial component, an anti-mold component and an insect-controlling component, and a fat or oil component such as a fatliquoring agent, impregnated into tissue and fiber of animal hide or skin using a high pressure fluid as a medium.

3. A method for producing a material to be processed into leather products such as leather and fur, comprising impregnating at least one effective component of an aromatic component, a deodorant component, a drug effective component, an antibacterial component, an anti-mold component and an insect-controlling component into tissue and fiber of animal hide or skin, using a high pressure fluid as a medium.

4. The method for producing a material to be processed into leather products such as leather and fur according to claim 3, wherein, before impregnating at least one effective component of an aromatic component, a deodorant component, a drug effective component, an antibacterial component, an anti-mold component and an insect-controlling component impregnate into tissue and fiber of hide or skin, removing impurities such as fat and water remaining in the tissue and the fiber.

5. The method for producing a material to be processed into leather products such as leather and fur according to claim 4, wherein the impurities are removed using a high pressure fluid.

6. A method for producing a material to be processed into leather products such as leather and fur, wherein a fat or oil component such as a fatliquoring agent is impregnated into tissue and fiber of animal hide or skin using a high pressure fluid as a medium.

7. A method for producing a material to be processed into leather products such as leather and fur according to claim 6, wherein the fatliquoring agent is impregnated into tissue and fiber of animal hide or skin in a fat-adding step in a step of tanning hide or skin.

8. A method for producing a leather product such as leather, fur and the like, which comprises impregnating at least one effective component of an aromatic component, a deodorant component, a drug effective component, an antibacterial component, an anti-mold component and an insect-controlling component into tissue and fiber of animal hide or skin using a high pressure fluid as a medium.

9. A method for producing a leather product such as leather and fur according to claim 8, wherein before impregnating at least one effective component of an aromatic component, a deodorant component, a drug effective component, an antibacterial component, an anti-mold component and an insect-controlling component into tissue and fiber of animal hide or skin, removing impurities such as fat and water remaining in the tissue and the fiber.

10. A method for producing a leather product such as leather and fur according to claim 9, wherein the impurities are removed using a high pressure fluid.

11. A method for producing a leather product such as leather and fur comprising impregnating a fat or oil component such as a fatliquoring agent into tissue and fiber of hide or skin using a high pressure fluid as a medium.

12. A method for producing a leather product such as leather and fur according to claim 11, wherein the fatliquoring agent is impregnated into tissue and fiber of hide or skin in a fat-adding step in a step of tanning hide or skin.
